(19) United States
(12) Patent Application Publication
(10) Pub. No.: US 2003/0063048 A1
(43) Pub. Date: Apr. 3, 2003

(54) Active matrix display device and data line switching circuit, switching section drive circuit, and scanning line drive circuit thereof

(75) Inventors: Taketoshi Nakano, Yokohama-shi (JP); Keishi Nishikubo, Yokohama-shi (JP); Takafumi Kawaguchi, Funabashi-shi (JP)

Correspondence Address: EDWARDS & ANGELL, LLP, P.O. BOX 9169, BOSTON, MA, 02209, US

(73) Assignee: Sharp Kabushiki Kaisha

(21) Appl. No.: 10/263,229

(22) Filed: Oct. 2, 2002

(30) Foreign Application Priority Data
Oct. 3, 2001 (JP) 2001-307941
Oct. 3, 2001 (JP) 2001-307943

(51) Int. Cl. G09G 3/20

(52) U.S. Cl. 345/55

(57) ABSTRACT

In an active matrix display device in which a data line switching circuit is provided and a plurality of data lines are grouped so as to be connected to one output of a data line drive circuit in order to reduce the number of the outputs of the data line drive circuit, switching elements constituting respective switching sections for selecting the data lines have a short life span so as to be unreliable in the long term. In contrast, a data line switching circuit in accordance with the present invention is provided with switching sections each composed of a plurality of switching elements connected in parallel to each other, so that the life span of the switching elements can be prolonged and the long-term reliability of the switching elements can be improved without obstructing the attempts such as narrowing a frame part and downsizing the whole device.

### FIELD OF THE INVENTION

The present invention relates to an active matrix display device such as a TFT (Thin Film Transistor) liquid crystal display device, and more particularly to an active matrix display device in which a plurality of data lines to which data signals as image signals are supplied are connected to one of the outputs of a data line drive circuit, and also a data line switching circuit, a switching section drive circuit, and a scanning line drive circuit of the active matrix display device.

### BACKGROUND OF THE INVENTION

Liquid crystal display devices have such advantages as facility for the reduction of thickness and small power consumption, compared with CRTs (Cathode Ray Tubes). With these advantages, liquid crystal display devices have recently been adopted not only as display devices of portable electronic devices but also as display devices of desktop electronic devices such as personal computers. In particular, active matrix liquid crystal display devices in which liquid crystal is driven by a switching element provided in respective pixels have received attention thanks to their intrinsic high-contrast which enables to increase the speed of response.

As the switching elements provided in the respective pixels, elements such as non-linear resistor elements and semiconductor elements are adopted, and above all, TFTs formed on a transparent insulating substrate are suitably used, on account of their adoptability for transparent displaying and easiness to produce a large-sized screen.

For instance, there is a conventional active matrix liquid crystal display device of the kind, arranged such that switching sections corresponding to respective data lines to which data signals are supplied are provided on the signal input side of the data line, and a plurality of the data lines are grouped so as to be connected to one output of a data line drive circuit. With this arrangement, the switching sections are selectively driven and the data signals outputted from the data line drive circuit are distributed to each group of the data lines.

This arrangement aims at reducing the number of the outputs of the data line drive circuit. Simple mathematics prove that the number of output signal lines when 2 data lines are paired up is half of the number of output signal lines in the case of one-to-one connection of the data lines and the output signal lines, and the number of the output signal lines when 3 data lines are grouped is one third of the number in the case of the one-to-one connection.

For instance, the display device of a portable electronic device is arranged in such a manner that each of the colors R (Red), G (Green), and B (Blue) corresponds to 176 data lines. In this arrangement, provided that 2 data lines are paired up so as to be connected to one output signal line of a data line drive circuit, it is possible to reduce the number of required output signal lines from 528 on occasion of one-to-one connection to 264.

As the switching sections which enable to switch and select the data lines, TFTs which can be manufactured in the process of manufacturing switching elements for driving liquid crystal are adopted.

Now, referring to FIG. 20, the liquid crystal display device in which each of the output of the data line drive circuit is connected to a plurality of the data lines will be described below. FIG. 20 is an equivalent circuit diagram illustrating a liquid crystal display device with this arrangement.

In the figure, a member 100 is a liquid crystal panel as a display panel (active matrix display panel). Although not illustrated, the liquid crystal panel 100 is composed of a matrix substrate, an opposing substrate which faces the matrix substrate with a predetermined distance, and liquid crystal which fills up the space between the substrates.

The matrix substrate is provided with data lines DL1 through DLN running in parallel with each other and gate lines (scanning lines) GL1 through GLM crossing the data lines DL and running in parallel with each other. To each of the gate lines GL, a gate signal is supplied from a gate line drive circuit 200 at the timing corresponding to each of the gate lines GL. The gate signal has an ON-voltage (select voltage) and an OFF-voltage (non-select voltage). To each of the data lines DL, a data signal (image signal) corresponding to each of the data lines DL is supplied from a data line drive circuit 3.

The data lines DL cross the gate lines GL at intersections each provided with a pixel electrode (not illustrated) and a pixel TFT 11. The pixel electrode and an opposing electrode 12 (specifically described below) provided on the opposing substrate form a liquid crystal capacitance 10. This liquid crystal capacitance 10 constitutes a pixel which is a unit of displaying. The pixel TFT 11 is provided for electrically connecting the pixel electrode to the corresponding data line DL, and controlling the writing of the data signal to the pixel electrode. The pixel TFT 11 is arranged in such a manner that the gate electrode thereof is connected to the corresponding gate line GL, the source electrode thereof is connected to the corresponding data line DL, and the drain electrode thereof is connected to the pixel electrode.

In this arrangement, when the gate electrode of the pixel TFT 11 is receiving the ON-voltage from the gate line drive circuit 200 via the gate line GL (writing period), the pixel TFT 11 is in on-state (state of low resistance). When the pixel TFT 11 is in the on-state, an electric potential (voltage) of the data signal supplied from the data line drive circuit 3 to the data line DL is supplied from the data line drive circuits to the pixel electrode, so that the electric potential of the pixel electrode becomes equivalent to the electric potential of the data line DL.

In contrast, when the gate electrode of the pixel TFT 11 is receiving the OFF-voltage from the gate line drive circuit 200 (keep period), the pixel TFT 11 is in off-state (state of high resistance). When the pixel TFT 11 is in the off-state, the electric potential of the pixel electrode is kept to be equivalent to the electric potential at the time of writing.

On the opposing substrate which is the other substrate constituting the liquid crystal panel 100, opposing electrodes 12 are formed. Each of the opposing electrodes 12 is the other electrode constituting the liquid crystal capacitance 10. The opposing electrodes 12 are formed on the entire surface of the opposing substrate, and each of them is provided in each of the pixels in a uniform manner. To these opposing electrodes 12, an appropriate common voltage is supplied from the side of the matrix substrate via common terminals (not illustrated) provided around the matrix substrate.

The liquid crystal capacitance 10 receives a voltage equivalent to the difference (electric potential difference) between the electric potential of the pixel electrode and that of the opposing electrode. The optical transmittance of the liquid crystal is controlled by regulating this voltage supplied to the liquid crystal capacitance 10, and this enables to display images.

This liquid crystal panel 100 is notable for a data line switching circuit 101 which is provided at each of the junctions of the data lines DL formed on the matrix substrate and the respective data line drive circuits 3 for driving the corresponding data lines DL.

The data line switching circuit 101 is composed of data line selecting TFTs 13 and input signal lines each connecting a plurality of the data lines DL as a group via the corresponding data line selecting TFTs 13. Both of the data line selecting TFTs 13 and the input signal lines are specifically described later. The data line switching circuit 101 determines which one of the grouped data lines DL receives the signal supplied from the data line circuit 3 via the corresponding output signal line D.

Each of the data lines DL is provided with a data line selecting TFT (switching element) 13 constituting the switching section. A plurality of the data lines DL are grouped so as to be connected to a common line via the corresponding data line selecting TFTs 13, and this common line is connected to the corresponding output signal line D of the data line drive circuit 3. This common line, to which a plurality of the data lines DL are connected via the corresponding data line selecting TFTs 13 which are the switching sections, is the input signal line.

In the figure, 2 data lines DL are paired up as a group. More specifically, a first group of the data lines DL1 and DL2 are connected to an output signal line D1 of the data line drive circuit 3 via respective data line selecting TFTs 13-1a and 13-1b. Similarly, a second group of the data lines DL3 and DL4 are connected to an output signal line D2 via respective data line selecting TFTs 13-2a and 13-2b. Since the total number N of the data lines DL is 10 in the figure, 5 groups of the paired data lines, the first group to the fifth group, are provided.

Among these 10 data line selecting TFTs 13, data line selecting TFTs 13-1a, 13-2a, 13-3a, . . . , connected to the odd-numbered data lines DL, are type a, and each of these type a data line selecting TFTs has a gate electrode connected to a gate line Ga, and the switching of the gate electrode is controlled by a data line selection signals supplied from a switching section drive circuit 102 to the gate line Ga. In the meantime, the TFTs 13-1b, 13-2b, 13-3b, . . . , connected to the even-numbered data lines DL, are type b, and each of these type b data line selecting TFTs has a gate electrode connected to a gate line Gb, and the switching of the gate electrode is controlled by a data line selection signals supplied from a switching section drive circuit 102 to the gate line Gb. The data line selection signals also has an ON-voltage corresponding to the selection voltage and an OFF-voltage corresponding to the non-selection voltage, in the same manner as the gate signal.

These data line selecting TFTs 13 constituting the data line switching circuit 101 are formed on the matrix substrate constituting the liquid crystal panel 100 in the same manufacturing process as that of the pixel TFTs 11.

FIG. 21 illustrates an arrangement of a switching section drive circuit 102 which outputs the data line selection signals to gate lines Ga and Gb.

The switching section drive circuit 102 is composed of 2 level shifter circuits 102a and 102b. The level shifter circuits 102a and 102b receive respective switching signals SW1 and SW2 from a drive control circuit 106. The supplied switching signals SW1 and SW2 are subjected to level conversion so as to be converted to either an ON-voltage V_{DSH} supplied to first input terminals IN01 of the respective level shifter circuits 102a and 102b or an OFF-voltage V_{DSL} supplied to second input terminals IN02 of the respective level shifter circuits 102a and 102b. The ON-voltage V_{DSH} is a voltage which turns on the data line selecting TFTs 13, and the OFF-voltage V_{DSL} is a voltage which turns off the data line selecting TFTs 13.

The converted signals are supplied from output terminals OUT of the respective level shifter circuits 102a and 102b to the gate lines Ga and Gb which are connected to the respective output terminals OUT, as the data line selection signals.

That is to say, the switching signal SW1 is supplied to the level shifter circuit 102a so that the data line selection signals which is a drive signal for controlling the type a data line selecting TFTs 13 is produced and then outputted from the output terminal OUT. Likewise, the switching signal SW2 is supplied to the level shifter circuit 102b so that the data line selection signals which is a drive signal for controlling the type b data line selecting TFTs 13 is produced and then outputted from the output terminal OUT.

FIG. 22 illustrates waveforms of drive signals (vertical sync signals, data signals, data line selection signals supplied to the gate lines Ga and Gb, and the gate signals supplied to the gate lines GL1-GLM) supplied to the liquid crystal panel 100 of the aforementioned liquid crystal display device. Here, the pixel TFTs 11 and the data line selecting TFTs 13 are turned on with a positive voltage as in the case of n-channel FETs, and the total number M of the gate lines GL is 8.

As illustrated in FIG. 22, one horizontal period, over which the select voltage is supplied to the gate lines GL, consists of 2 phases. In each of the phases, the data line selection signals supplied to the gate lines Ga and Gb turn on either one of the type a and type b data line selecting TFTs 13 of the data line switching circuit 101. Thus, among all of the data lines DL, only the data lines DL connected to the data line selecting TFTs 13 which have been turned on receive the data signals from the data line drive circuit 3, so that the data signals are written in the respective pixel electrodes connected to these data line DL.

As described above, liquid crystal display devices have conventionally been arranged so that a data line switching circuit 101 is provided on a matrix substrate, and this data line switching circuit 101 distributes the data signals, which are outputted from output signal lines D of the data line drive circuit 3, to a plurality of the data lines DL connected to each corresponding output signal line D, so that the required number of the output signal lines D of the data line drive circuit 3 is reduced.

In the one-to-one arrangement in which one data line DL is connected to one output of the data line drive circuit 3, the pitch between connection parts, at which the output signal lines D and the respective data lines DL are connected to each other, is narrow in the case of a high-definition display panel. On this account, the reliability of the connection parts is degraded, when the data line drive circuit 3 is externally provided. In contrast, the above-mentioned arrangement makes it possible to reduce the number of the connection parts at which the output signal lines D and the respective data lines DL are connected to each other, so that the pitch between the connection parts can be arranged to be wide and the reliability of the connection parts can be maintained.

Moreover, when adopting the liquid crystal display devices as a display device of the portable electronic device as described above, the design freedom of the products is severely limited, if the peripheral part of the display area, i.e. a frame part is large in size. However, the aforementioned arrangement enables to reduce the number of the output signal lines D of the data line drive circuit 3 so that the number of the required data line drive circuits 3 also decreases (although the number of the same is 1 in the figure, a plurality of the circuits are provided when the number of the data lines DL is large). On this account, it is possible to reduce the area of the frame part occupied with the data line drive circuit 3, and increase the design freedom of the products.

Liquid crystal devices adopting this type of arrangement are described in documents such as Japanese Laid-Open Patent Application No. 56-92573 (Tokukaisho 56-92573; published on Jul. 27, 1981), Japanese Laid-Open Patent Application No. 61-223791 (Tokukaisho 61-223791; published on Oct. 4, 1986), Japanese Laid-Open Patent Application No. 4-322216 (Tokukaihei 4-322216; published on Nov. 12, 1992), Japanese Laid-Open Patent Application No. 6-138851 (Tokukaihei 6-138851; published on May 20, 1994), and Japanese Laid-Open Patent Application No. 8-234237 (Tokukaihei 8-234237; published on Sep. 13, 1996).

The liquid crystal device is arranged so that an output of the conventional data line drive circuit 3 is connected to a plurality of the data lines DL and the data line switching circuit 101 determines which one of the plurality of the data lines DL receives the signal supplied from the data line, and hence the liquid crystal display device with this arrangement has the following advantages: a large-sized frame part is not required so that high design freedom is acquired, and the number of the connection parts at which the output signal lines D and the respective data lines DL are connected to each other can be reduced. However, the reliability of this liquid crystal device as a display device is questionable in the long term.

This unreliability arises from the switching sections constituting the data line switching circuit 101. That is to say, as described above, TFTs are adopted as the switching elements constituting the switching sections of the data line switching circuit 101, because of the advantages such that the TFTs can be manufactured in the same manufacturing process as that of the pixel TFTs 11. However, the frequency of driving of the data line selecting TFTs 13 is overwhelmingly higher than the frequency of driving of the pixel TFTs 11.

For instance, comparing a pixel TFT 11-1 provided between a data line DL1 and a corresponding gate line GL1 with a TFT 13-1a which makes it possible to supply a data signal to the data line DL1, while the pixel TFT 11-1 is turned on once in one vertical period, the data line selecting TFT 13-1a is turned on once in one horizontal period. Provided that the total number M of the gate line GL is 220, a simple calculation demonstrates that the frequency of driving the data line selecting TFTs 13 is 220 times higher than the frequency of driving the pixel TFTs 11.

For this reason, even if normal-sized amorphous TFTs (TFT adopting amorphous silicon as a semiconductor layer of a channel section) has enough reliability when adopted as a pixel TFTs 11, when these TFTs are adopted as a data line selecting TFTs 13 which are frequently driven, the switching characteristics thereof is degraded during use so that the TFTs do not function properly, and this causes problems on the occasion of using the TFTs as a display device for long periods.

The long-term reliability of TFTs is easily raised by widening the channel width of the TFTs. However, widening the channel width causes the increase of power consumption. In addition, since the size of the TFTs becomes large, it is necessary to enlarge the size of a matrix substrate on which the TFTs are mounted, and furthermore, a drawing of the output signal (image signal) is caused by the increase of the parasite capacitance. Therefore the method to raise the ling-term reliability of the TFTs by widening the channel width is unfavorable.

The method above has another problem, namely a large number of components is required.

That is to say, in the arrangement above, the switching section drive circuit 102 has to be additionally provided for driving the data line switching circuit 101, along with the data line drive circuit 3 and the gate line drive circuit 200.

The ON-voltage and OFF-voltage of the data line selecting TFTs 13 of the data line switching circuit 101 are not in normal logic levels, as in the case of the pixel TFTs 11. For this reason, as illustrated in FIG. 21, the gate lines Ga and Gb have to be provided with the respective level shifter circuits 102a and 102b as in the case of the gate line drive circuit 103, and the switching section drive circuit 102 is provided.

As a result, even if the number of the output signal lines D of the data line drive circuit 3 is reduced for reducing the area of the frame part occupied with the data line drive circuit 3, this reduction of the area does not really create an available space because of the requirement of additionally providing the switching section drive circuit 102. In particular, the increase of the number of the required components on account of the addition of the switching section drive circuit 102 is a crucial demerit when the data line drive circuit 3 and the gate line drive circuit 200, etc. are externally attached to the liquid crystal panel 100.

Furthermore, the aforementioned liquid crystal display device in which one output of the data line drive circuit 3 is connected to a plurality of the data lines DL additionally requires electric power for switching the data line selecting TFTs 13, so that the power consumption is increased.

### SUMMARY OF THE INVENTION

A first object of the present invention is to provide a data line switching circuit of an active matrix display panel, which can increase a long-term reliability without inhibiting a reduction in the area of a frame part and a downsizing in the active matrix display device which adopts an arrangement in which the data line switching circuit is provided so as to reduce the number of outputs in a data line drive circuit.

A second object of the present invention is to provide an active matrix display device which enables a further reduction in the area of the frame part, a reduction of external components, and a reduction in cost, which is accompanied by the reduction of the external components, in addition to the reduction in the number of outputs in the data line drive circuit.

A third object of the present invention is to provide an active matrix display device which can further maintain a long-term reliability, while enabling the reduction in the number of outputs in the data line drive circuit, a further reduction in the area of the frame part, a reduction of the external components, and a reduction in cost, which is accompanied by the reduction of the external components.

In order to achieve the first object, a data line switching circuit of an active matrix display panel of the present invention, having a scanning line and a plurality of data lines which are crossed with the scanning line,

the data line switching circuit, includes:

switching sections which are provided for the respective data lines on a signal input side of the data lines; and

input signal lines each of which combines the data lines as one group via the respective switching sections,

wherein the switching sections for the respective data lines as one group are caused to drive alternatively so that a data signal inputted from the input signal line is supplied to one of the data lines as one group, and

each of the switching sections is composed of a plurality of switching elements which are connected in parallel to each other.

The above data line switching circuit is composed of a plurality of switching elements (hereinafter, simply referred to as “element” in some cases), which are connected in parallel to each other, so that driving one element out of the elements constructing the switching section enables the data signal inputted from the input signal line to be outputted to one of the data lines which are connected to the respective switching sections.

Therefore, properly driving the plurality of elements which construct the switching section makes it possible to increase a long-term reliability, thereby obtaining a long-term reliability, as compared with the conventional switching section having an arrangement of one element.

As compared with an arrangement of the switching section having one element increased in size for increasing a long-term reliability of the switching section, such an arrangement of the switching section having the plurality of elements can reduce an area occupied with one switching section in case where the same level of long-term reliability can be obtained, so that it is possible to increase a long-term reliability without inhibiting a reduction in the area of the frame part and a downsizing of the active matrix display panel.

In order to achieve the second object, an active matrix display device, includes:

(a) an active matrix display panel having a scanning line and a plurality of data lines which are crossed with the scanning line;

(b) a data line switching circuit, including:

switching sections which are provided for the respective data lines on a signal input side of the data lines; and

input signal lines each of which combines the data lines as one group via the respective switching sections,

the switching sections for the respective data lines as one group being caused to drive alternatively so that a data signal inputted from the input signal line is supplied to one of the data lines as one group;

(c) a switching section drive circuit for outputting data line selecting signals each having an ON-voltage and an OFF-voltage in accordance with drive signals supplied from a drive control circuit so as to drive the switching sections in the data line switching circuit;

(d) a data line drive circuit for outputting to the data lines data signals in accordance with the respective data lines; and

(e) a scanning line drive circuit for outputting gate signals each having an ON-voltage and an OFF-voltage to the scanning line at a timing in accordance with the scanning line,

the switching section drive circuit being mounted in the scanning line drive circuit.

In the above active matrix display device, the switching section drive circuit, mounted in the scanning line drive circuit, makes it possible to reduce the number of components. On this account, the area occupied with these circuit components is reduced more on the frame part so that the layout of circuits on the frame part can be flexibly arranged, and consequently the frame part can be downsized. Also in the case of externally attaching the drive circuits such as the scanning line drive circuit and the data line drive circuit, the arrangement above enables to do away with the process to connect the switching section drive circuit to a liquid crystal panel, and hence it is possible to reduce the manufacturing cost.

In such a case, both of the switching section drive circuit and the scanning line drive circuit are composed of level shifter circuits, so that it is advantageous because incorporating the switching section drive circuit into the gate line drive circuit can be carried out without significant changes in manufacturing steps of the gate line drive circuit.

In order to achieve the third object, in the active matrix display device of the present invention, in addition to the above arrangement, the scanning line drive circuit includes a plurality of settable ON-voltages, and a data line selecting signal differs from a scanning signal in an absolute value of an ON-voltage.

In an arrangement in which the switching section drive circuit is mounted in the scanning line drive circuit, although also considered is an arrangement of the ON-voltage of the data line selecting signal having the same ON-voltage as the scanning signal outputted to the scanning line, a pixel switching element driven by the scanning signal differs in functions from the switching section driven by the data line selecting signal, so that ON-voltages suitable for the data line selecting signal and the scanning signal are different from each other.

Thus, it is possible to make the switching sections to function properly by setting the absolute value of the ON-voltage of the data line selecting signal to a voltage value suitable for functions of the switching section driven by the data line selecting signal, as a value different from that of the ON-voltage of the scanning signal.

All the switching section of the data line switching circuit has to do is to supply the respective data signals supplied from the data line drive circuit to the respective data lines connected in a good condition, so that it can fulfill the function without setting the ON-voltage of the data line selecting signal as high as the ON-voltage of the scanning signal. Therefore, setting the ON-voltage of the data line selecting signal to a value suitable for its function makes it possible to increase a reliability of a switching characteristic of the switching section in the data line switching circuit, thereby maintaining a long-term reliability of the switching section.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is an equivalent circuit diagram showing an arrangement of an active matrix liquid crystal display device in accordance with an embodiment of the present invention.

FIG. 2 is a block diagram illustrating a schematic arrangement of a switching section drive circuit for driving switching sections of a data line switching circuit provided in the active matrix display device shown in FIG. 1.

FIG. 3 is waveform charts indicating various drive signals supplied to a liquid crystal panel of the active matrix display device shown in FIG. 1

FIG. 4 is a circuit diagram illustrating an important part of another data line switching circuit in which 2 data lines are paired up as a group and the switching section of each data line is provided with 3 data line selecting TFTs.

FIG. 5 is a circuit diagram illustrating an important part of a further data line switching circuit in which 3 data lines are grouped and the switching section of each data line is provided with 2 data line selecting TFTs.

FIG. 6 is a block diagram illustrating a schematic arrangement of a switching section drive circuit for driving the switching sections of the data line switching circuit illustrated in FIGS. 4 and 5.

FIG. 7 is a plan view of the active matrix display device in FIG. 1, indicating a layout of drive circuits in the liquid crystal panel.

FIG. 8 is an equivalent circuit diagram illustrating an arrangement of an active matrix liquid crystal display device in accordance with another embodiment of the present invention.

FIG. 9 is a block diagram illustrating an arrangement of a gate line drive circuit including a switching section drive circuit, provided in the active matrix display device shown in FIG. 8.

FIG. 10 is a block diagram illustrating a schematic arrangement of the switching section drive circuit included in the gate line drive circuit illustrated in FIG. 9.

FIG. 11 is waveform charts indicating a control signal supplied to the switching section drive circuit illustrated in FIG. 10 and data line selection signals outputted from the same circuit.

FIG. 12 is waveform charts of drive signals supplied to a liquid crystal panel in the active matrix display device illustrated in FIG. 8.

FIG. 13 is a block diagram illustrating an alternative arrangement of the gate line drive circuit including the switching section drive circuit, provided in the active matrix display device illustrated in FIG. 8.

FIG. 14 is a plan view of the active matrix display device illustrated in FIG. 8, indicating a layout of various drive circuits of the liquid crystal panel.

FIG. 15 is an equivalent circuit diagram illustrating an arrangement of an active matrix liquid crystal display device in accordance with a further embodiment of the present invention.

FIGS. 16(a) and 16(b) are block diagrams both illustrating an arrangement of a gate line drive circuit in which a switching section drive circuit is incorporated, which can be included in the active matrix display device illustrated in FIG. 15.

FIG. 17 is a block diagram illustrating a schematic arrangement of the switching section drive circuit included in the gate line drive circuit shown in FIG. 16(b).

FIG. 18 is waveform charts indicating a control signal supplied to the switching section drive circuit illustrated in FIG. 17 and data line selection signals outputted from the same circuit.

FIG. 19 is waveform charts showing various drive signals supplied to a liquid crystal panel of the active matrix display device illustrated in FIG. 15.

FIG. 20 is an equivalent circuit diagram illustrating a conventional active matrix display device.

FIG. 21 is a block diagram illustrating a schematic arrangement of a switching section drive circuit included in the active matrix display device shown in FIG. 20.

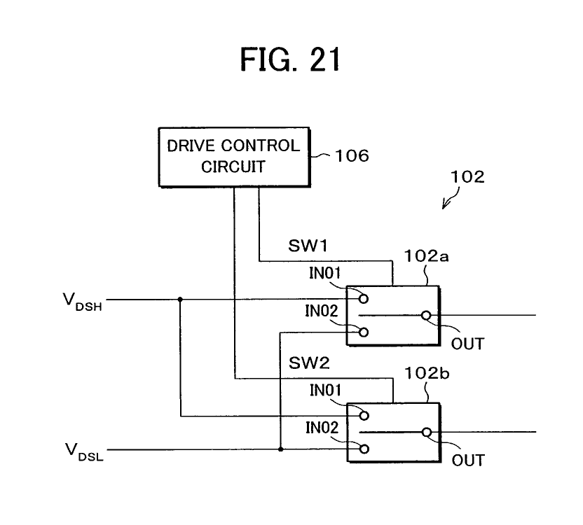

FIG. 22 is waveform charts indicating drive signals supplied to a liquid crystal panel of the active matrix display device illustrated in FIG. 20.

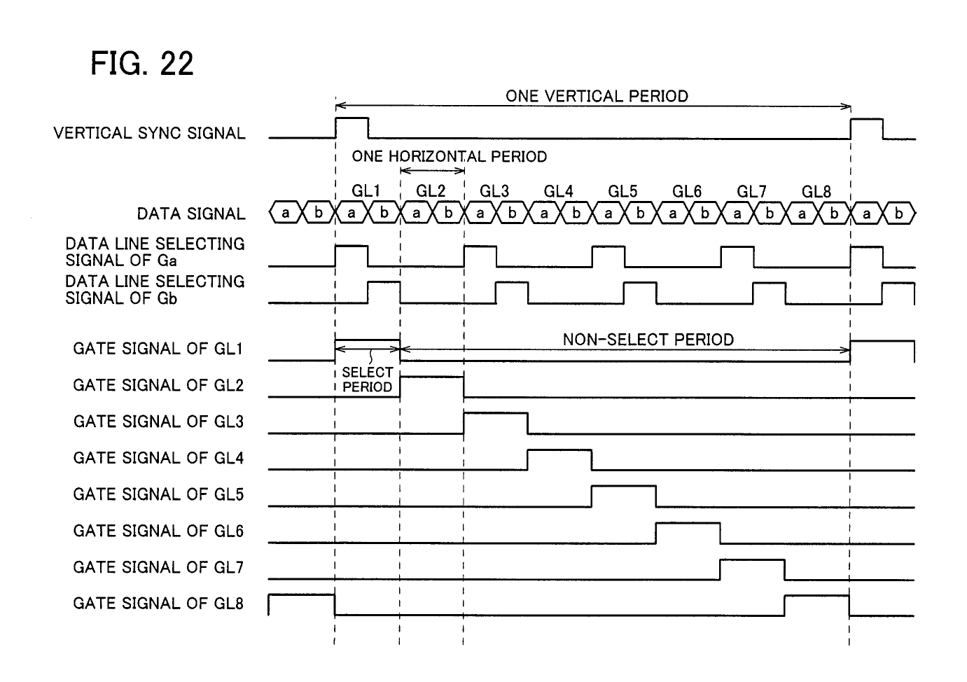

### DESCRIPTION OF THE EMBODIMENTS

The present invention relates to an active matrix display device which is arranged in such a manner that a plurality of data lines are grouped so as to be connected to one output of a data line drive circuit for the sake of reduction of the number of outputs of the data line drive circuit.

Moreover, in this arrangement, each of switching sections provided on respective data lines of a data line switching circuit is composed of a plurality of switching elements, aiming at maintaining the long-term reliability of the switching sections so as to raise the long-term reliability of the liquid crystal display device.

Furthermore, in the arrangement above, a switching section drive circuit for driving the switching sections provided on the respective data lines of the data line switching circuit is provided in a gate line drive circuit for driving gate lines which are scanning lines, aiming at the narrowing of the frame, the reduction of the number of components of externally provided members, and consequently the cost reduction.

Moreover, in the arrangement of providing the switching section drive circuit in the gate line drive circuit, in order to maintain the long-term reliability of the switching sections provided on the respective switching sections, one gate line drive circuit outputs data line selection signals for driving the switching sections each provided on each of the data lines and a gate signal for driving pixel switches, and more than one type of ON-voltages can be arranged in the aforementioned signals so that the ON-voltage of the data line selection signals is different from that of the data signals.

Furthermore, in order to effectively reduce the electric power consumed by the driving of the switching sections, when the switching sections provided on the respective data lines are driven, the switching of the voltage level of the data line selection signals from the OFF-voltage to the ON-voltage or from the ON-voltage to the OFF-voltage is carried out with an interval to keep an intermediate electric potential which is a voltage between the ON-voltage and the OFF-voltage.

By the way, as an active matrix display device, embodiments described below exemplify an active matrix liquid crystal display device using liquid crystal. However, the present invention is not limited to the use of liquid crystal so that any kind of materials can be adopted as long as the same can be driven in an active matrix manner and can store a data signal which is temporarily written in a pixel or a bus line.

[Embodiment 1]

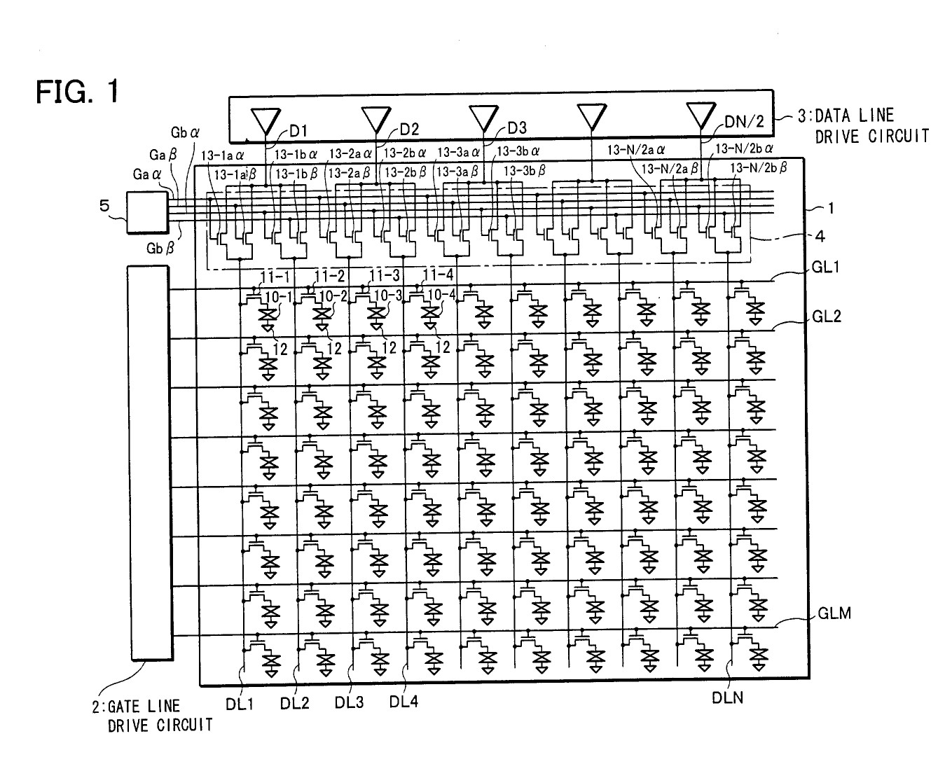

Referring to FIGS. 1 through 7, the descriptions below will discuss an embodiment in accordance with the present invention.

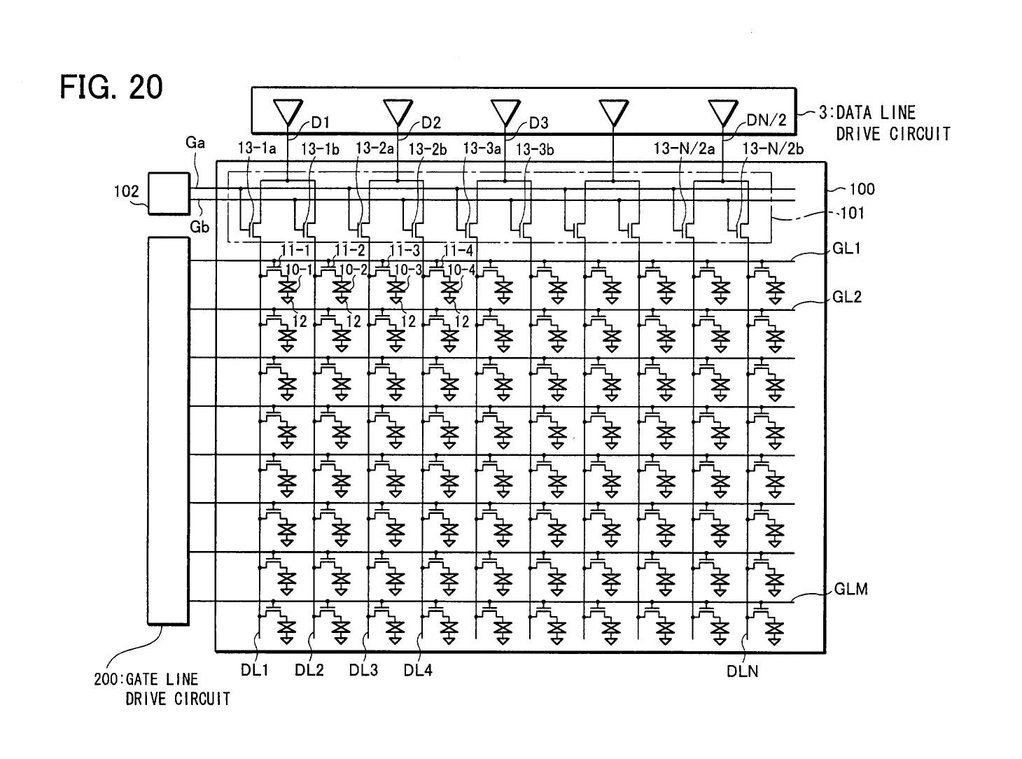

FIG. 1 is an equivalent circuit diagram illustrating an arrangement of an active matrix liquid crystal display device in accordance with the present embodiment. In this figure, members having the same functions as those described referring to FIG. 20 are given the same numbers.

So, in FIG. 1, a member 1 is a display panel (active matrix display panel), and although not particularly illustrated, the liquid crystal panel 1 includes a matrix substrate, an opposing substrate which is provided so as to be in parallel with the matrix substrate with a predetermined distance, and liquid crystal which fills up the space between the substrates.

The matrix substrate is provided with data lines DL1 through DLN running in parallel with each other and gate lines (scanning lines) GL1 through GLM crossing the data lines DL and running in parallel with each other. To each of the gate lines GL, gate signals are supplied from a gate line drive circuit 2 at the timing in accordance with each of the gate lines GL. The gate signal has an ON-voltage (select voltage) and an OFF-voltage (non-select voltage). To each of the data lines DL, data signals (image signals) corresponding to each of the respective data lines DL are supplied from a data line drive circuit 3.

The data lines DL cross the gate lines GL at intersections each provided with a pixel electrode (not illustrated) and a pixel TFT 11. The pixel electrode and an opposing electrode 12 (specifically described below) provided on the opposing substrate form a liquid crystal capacitance 10. This liquid crystal capacitance 10 constitutes a pixel which is a unit of displaying. The pixel TFT 11 is provided for electrically connecting the pixel electrode to the corresponding data line DL, and controlling the writing of the data signal to the pixel electrode. The pixel TFT 11 is arranged in such a manner that the gate electrode thereof is connected to the corresponding gate line GL, the source electrode thereof is connected to the corresponding data line DL, and the drain electrode thereof is connected to the pixel electrode.

In this arrangement, when the gate electrode of the pixel TFT 11 is receiving the ON-voltage from the gate line drive circuit 2 via the gate line GL (writing period), the pixel TFT 11 is in on-state (state of low resistance). When the pixel TFT 11 is in the on-state, the electric potential (voltage) of the data signal supplied from the data line drive circuit 3 to the data line DL is supplied to the pixel electrode, so that the electric potential of the pixel electrode becomes equivalent to the electric potential of the data line DL.

In contrast, when the gate electrode of the pixel TFT 11 is receiving the OFF-voltage from the gate line drive circuit 2 (keep period), the pixel TFT 11 is in off-state (state of high resistance). When the pixel TFT 11 is in the off-state, the electric potential of the pixel electrode is kept to be equivalent to the electric potential at the time of writing.

On the opposing substrate which is the other substrate constituting the liquid crystal panel 1, opposing electrodes 12 are formed. Each of the opposing electrodes 12 is the other electrode constituting the liquid crystal capacitance 10. The opposing electrode 12 are formed on the entire surface of the opposing substrate, and each of them is provided in each of the pixels in a uniform manner. To these opposing electrodes 12, an appropriate common voltage is supplied from the side of the matrix substrate via common terminals (not illustrated) provided around the matrix substrate.

The liquid crystal capacitance 10 receives a voltage equivalent to the difference (electric potential difference) between the electric potential of the pixel electrode and that of the opposing electrode. The optical transmittance of the liquid crystal is controlled by regulating the voltage supplied to the liquid crystal capacitance 10, and this makes it possible to display images.

In the liquid crystal panel 1, a plurality of the data lines DL, in this case 2 data lines DL are grouped so as to be connected to one output signal line D of the line drive circuit 3, as in the liquid crystal panel 100 illustrated in FIG. 20. The arrangement described up to this point is identical with that of the liquid crystal panel 100 illustrated in FIG. 20.

The difference between the liquid crystal panel 1 and the liquid crystal panel 100 is in a data line switching circuit 4. The data line switching circuit 4 is a circuit determining which group of the data lines DL receives the signal from the data line circuit 3.

The data line switching circuit 101 of the conventional liquid crystal panel 100 is composed of a single data line selecting TFT 13 (see FIG. 20). In contrast, as FIG. 1 illustrates, in the data line switching circuit 4 which is provided in the liquid crystal panel 1 of the liquid crystal display device in accordance with the present invention, each of the switching section provided on the respective data lines DL is composed of a plurality of the data line selecting TFTs 13 which are connected to each other in a parallel manner. In this arrangement, one switching section is composed of 2 data line selecting TFT 13 which are connected to each other in a parallel manner and each can be driven being independent of each other.

More specifically, when an output signal line D1 of the data line drive circuit 3 is connected to a first group of data lines DL1 and DL2, the data line DL1 is connected via data line selecting TFTs 13-1aα and 13-1aβ which are in parallel with each other, and the data line DL2 is connected via data line selecting TFTs 13bα and 13bβ which are in parallel with each other.

Also, when the output signal line D2 is connected to a second group of data lines DL3 and DL4, the data line DL3 is connected via data line selecting TFTs 13-2aα and 13-2aβ which are in parallel with each other, and the data line DL4 is connected via data line selecting TFTs 13-2bα and 13-2bβ which are in parallel with each other.

Since the total number N of the data lines DL is 10 in the figure, 5 pairs of the data lines from the first group to the fifth group are formed so that 20 data line selecting TFTs 13 are provided. These data line selecting TFTs 13 constituting the data line switching circuit 4 are also formed on the matrix substrate constituting the liquid crystal panel 1 in the same manufacturing process as that of the pixel TFTs 11.

Among these 20 data line selecting TFTs 13 constituting the data line switching circuit 4, 10 data line selecting TFTs, namely the TFTs 13-1aα and 13-1aβ, 13-2aα and 13-2aβ, 13-5aα and 13-5aβ connected to the odd-numbered data lines DL1, DL3, DL9, respectively, are type a.

Then among these 10 data line selecting TFTs categorized as the type a, 5 data line selecting TFTs with a, namely the data line selecting TFTs 13-1aα, 13-2aα, 13-5aα, are type a(α), so that the gate electrodes of the respective TFTs are connected to corresponding gate lines Gaα, and the switching of these gate electrodes is controlled by the data line selection signals supplied from a switching section drive circuit 5 to the gate lines Gaα.

Meanwhile, 5 data line selecting TFTs 13 with β, namely the data line selecting TFTs 13-1aβ, 13-2aβ, 13-5aβ, are type a(β), so that the gate electrodes of the respective TFTs are connected to corresponding gate lines Gaβ, and the switching of these gate electrodes is controlled by the data line selection signals supplied from the switching section drive circuit 5 to the gate lines Gaβ.

Similarly, 10 data line selecting TFTs, namely the data line selecting TFTs 13-1bα and 13-1bβ, 13-2bα and 13-2bβ, 13-5bα and 13-5bβ which are connected to the even-numbered data lines DL2, DL4, DL10, respectively, are type b.

Then among these 10 data line selecting TFTs of the type b, 5 data line selecting TFTs with α, namely the data line selecting TFTs 13-1bα, 13-2bα, 13-5bα are type b(α), so that the gate electrodes of the respective TFTs are connected to corresponding gate lines Gbα, and the switching of these gate electrodes is controlled by the data line selection signals supplied from the switching section drive circuit 5 to the gate lines Gbα.

In contrast, 5 data line selecting TFTs with β, namely the data line selecting TFTs 13-1bβ, 13-2bβ, 13-5bβ are type b(β), so that the gate electrodes of the respective TFTs are connected to corresponding gate lines Gbβ, and the switching of these gate electrodes is controlled by the data line selection signals supplied from the switching section drive circuit 5 to the gate lines Gbβ.

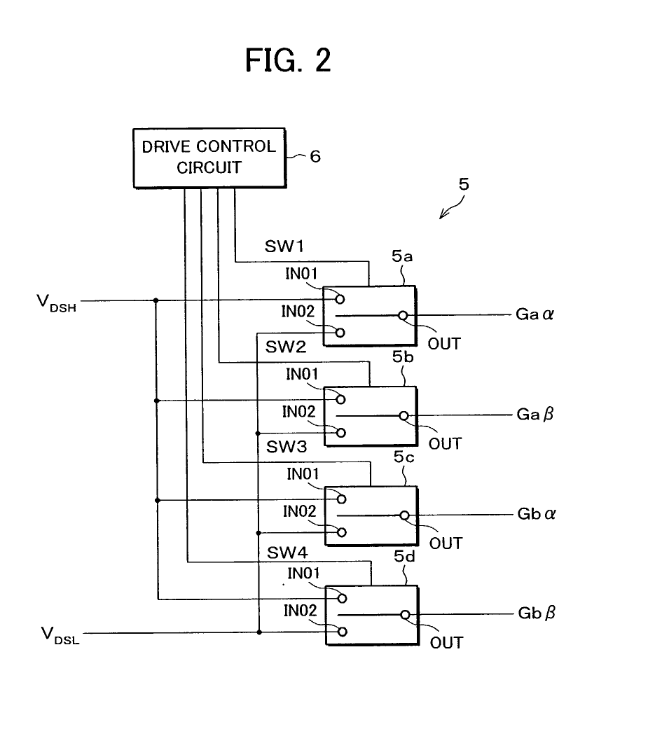

FIG. 2 illustrates an arrangement of the switching section drive circuit 5 which outputs the data line selection signals to the gate lines Gaα-Gaβ.

The switching section drive circuit 5 is composed of 4 level shifter circuits 5a through 5d. These level shifter circuit 5a-5d receive switching signals SW1 through SW4 respectively, from the drive control circuit 6. The switching signals SW1-SW4 which have been supplied are subjected to level conversion so as to be converted to either an ON-voltage V_{DSH} supplied to first input terminals IN01 of the respective level shifter circuits 5a-5d or an OFF-voltage V_{DSL} supplied to second input terminals IN02 of the respective level shifter circuits 5a-5d. The ON-voltage V_{DSH} is a voltage which turns the data line selecting TFTs 13 on, and the OFF-voltage V_{DSL} is a voltage which turns the data line selecting TFTs 13 off.

The converted outputs are supplied from output terminals OUT of the respective level shifter circuits 5a-5d to the gate lines Gaα-Gbβ connected to the respective output terminals OUT, as the data line selection signals.

In other words, the level shifter circuit 5a receives the switching signal SW1 so that a data line selection signals which is a drive signal for controlling the type a(α) data line selecting TFTs 13, is generated, and this data line selection signals is outputted from the output terminal OUT. In a similar manner, the level shifter circuit 5b receives the switching signal SW2 so that the data line selection signals which is a drive signal for driving the type a(β) data line selecting TFTs 13, is generated, and this data line selection signals is outputted from the output terminal OUT. The remaining level shifter circuits 5c and 5d also have similar arrangements.

As already described, since 2 data lines DL connected to a single output signal line D are not simultaneously driven, provided that one horizontal period, over which the select voltage is supplied to the gate lines GL, consists of 2 phases, and either type a or type b data line selecting TFTs 13 of the data line switching circuit 4 are turned on in each of the phases. In this case, the type a data line selecting TFTs 13 consist of 2 type a(α) TFTs and 2 type a(β) TFTs, whereas the type b data line selecting TFTs 13 consist of 2 type b(α) TFTs and 2 type b(β) TFTs. Thus, in the phase of selecting the type b TFTs, either a(α) type or a(β) type TFTs are selected, and in the phase of selecting b type TFTs, either b(α) type or b(β) type TFTs are selected.

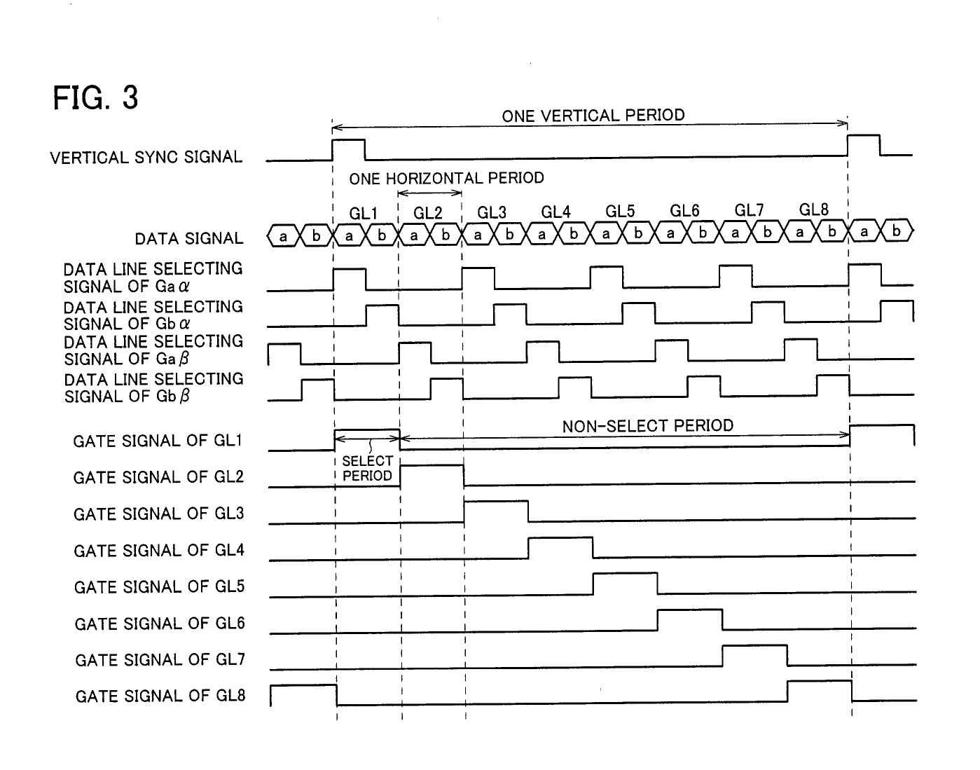

FIG. 3 illustrates waveforms of drive signals (vertical sync signals, the data signals, data line selection signals supplied to the gate lines Gaα-Gbβ, and gate signals supplied to the gate lines GL1-GLM) supplied to the liquid crystal panel 1 of the aforementioned liquid crystal display device. Here, the pixel TFTs 11 and the data line selecting TFTs 13 are turned on with a positive voltage as in the case of n-channel FETs, and the total number M of the gate lines GL is 8.

As illustrated in FIG. 3, this liquid crystal display device is arranged such that, when the ON-voltage is supplied to the first gate line GL1, a select period (equivalent to one horizontal period) is divided into 2 phases, so that in the first phase the type a(α) data line selecting TFTs 13 of the data line switching circuit 4 are turned on (by the data line selection signals supplied to the gate line Gaα), and in the second phase the type b(α) data line selecting TFTs 13 of the data line switching circuit 4 are turned on (by the data line selection signals supplied to the gate line Gbα).

Then at the time of supplying the ON-voltage to the second gate line GL2, in the first phase the type a(β) data line selecting TFTs 13 of the data line switching circuit 4 are turned on (by the data line selection signals supplied to the gate line Gaβ), and in the second phase the type b(β) data line selecting TFTs 13 of the data line switching circuit 4 are turned on (by the data line selection signals supplied to the gate line Gbβ).

The same processes are repeated from the third gate line GL3. So at the time of supplying the ON-voltage to the third gate line GL3, as in the case of the gate line GL1, in the first phase the type a(α) data line selecting TFTs 13 are turned on, and in the second phase the type b(α) data line selecting TFTs 13 are turned on. At the time of supplying the ON-voltage to the fourth gate line GL4, as in the case of the gate line GL2, in the first phase the type a(β) data line selecting TFTs 13 are turned on, and in the second phase the type b(β) data line selecting TFTs 13 are turned on.

In this manner, since 2 data line selecting TFTs 13, of the switching section provided between each of the output signal lines D of the data line drive circuit 3 and the corresponding data line DL, are provided in a parallel manner, the frequency of driving the data line selecting TFTs 13 is half as many as the same in the case where one data line selecting TFT 13 is provided on each of the data lines DL.

As a result, in the arrangement in which the number of the output signal lines D of the data line drive circuit 3 is reduced in order to downsize the data line drive circuit 3, it is possible to maintain the long-term reliability of the data line selecting TFTs 13 without enlarging the size of each the data line selecting TFT 13, and consequently it is possible to maintain the long-term reliability of the liquid crystal display device.

Incidentally, although 2 types (type α and type β) of the data line selecting TFTs 13 constituting the switching sections are alternately driven in each of the horizontal periods in the arrangement illustrated in FIG. 3, the present invention is not limited to this arrangement. The long-term reliability is maintained by sharing the required frequency of driving between 2 types of the data line selecting TFTs 13 and consequently reducing the frequency of driving the data line selecting TFTs 13. Thus, the order of driving the types of the data line selecting TFTs 13 is not particularly determined.

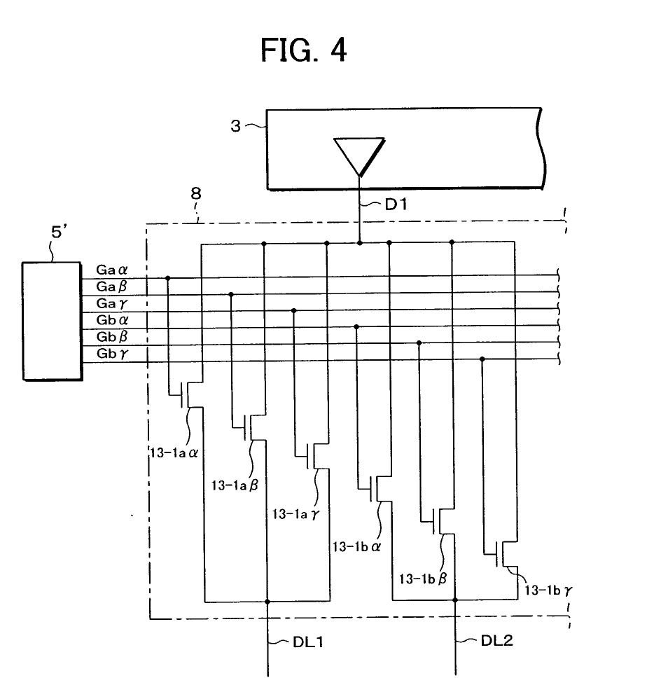

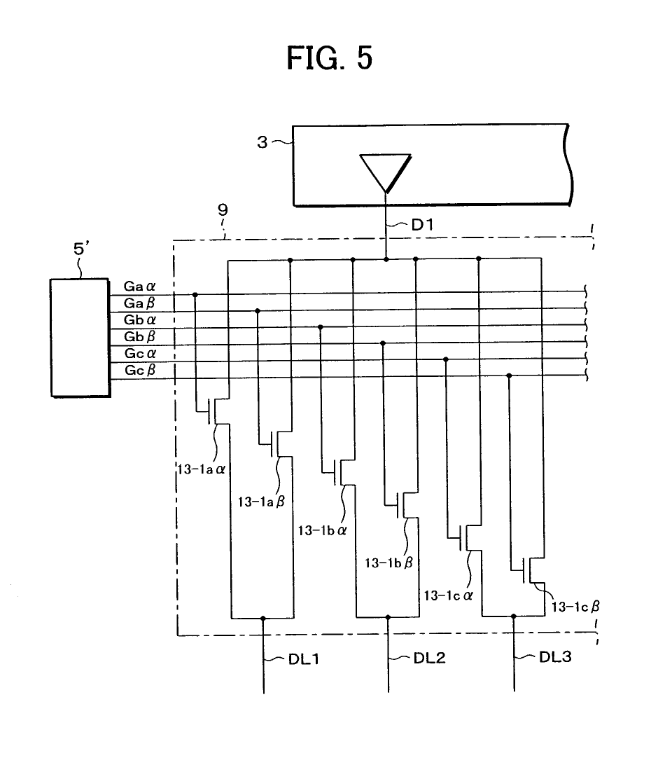

In the description of the present embodiment, 2 data lines DL are grouped and the number of the data line selecting TFTs 13 connected to one data line DL is 2. However, grouping X data lines DL (X=2 in this case) as one group makes it possible to reduce the number of the output signal lines D of the data line drive circuit 3 to 1/X, compared with the case of the one-to-one connection. Moreover, since Y data line selecting TFTs 13 (Y=2 in this case) which are connected to one data line DL and in parallel with each other are provided, the frequency of driving the data line selecting TFTs 13 can be reduced to 1/Y, compared with the case of providing only one data line selecting TFT on each of the data lines DL. As alternative arrangements, FIG. 4 illustrates a data line switching circuit 8 where the number X of the data lines DL to be grouped is 2 and the number Y of the data line selecting TFTs 13 to be connected to one data line DL is 3, and FIG. 5 illustrates a data line switching circuit 9 where X=3 and Y=2. In these FIGS. 4 and 5, only data lines DL driven by the output signal line D1 are illustrated for the sake of simplicity.

The data line switching circuit 8 shown in FIG. 4 is arranged in such a manner that, among 2 data lines DL1 and DL2 connected to an output signal line D1 of the data line drive circuit 3, the data line DL1 has a switching section which is provided with data line selecting TFTs 13-1aα, 13-1aβ, and 13-1aγ, and the data line DL2 has a switching section which is provided with data line selecting TFTs 13-1bα, 13-1bβ, and 13-1bγ.

The data line switching circuit 9 shown in FIG. 5 is arranged in such a manner that, among 3 data lines DL1, DL2 and DL3 connected to an output signal line D1 of the data line drive circuit 3, the data line DL1 has a switching section which is provided with data line selecting TFTs 13-1aα and 13-1aβ, the data line DL2 has a switching section which is provided with data line selecting TFTs 13-1bα and 13-1bβ, and the data line DL3 has a switching section which is provided with data line selecting TFTs 13-1cα and 13-1cβ.

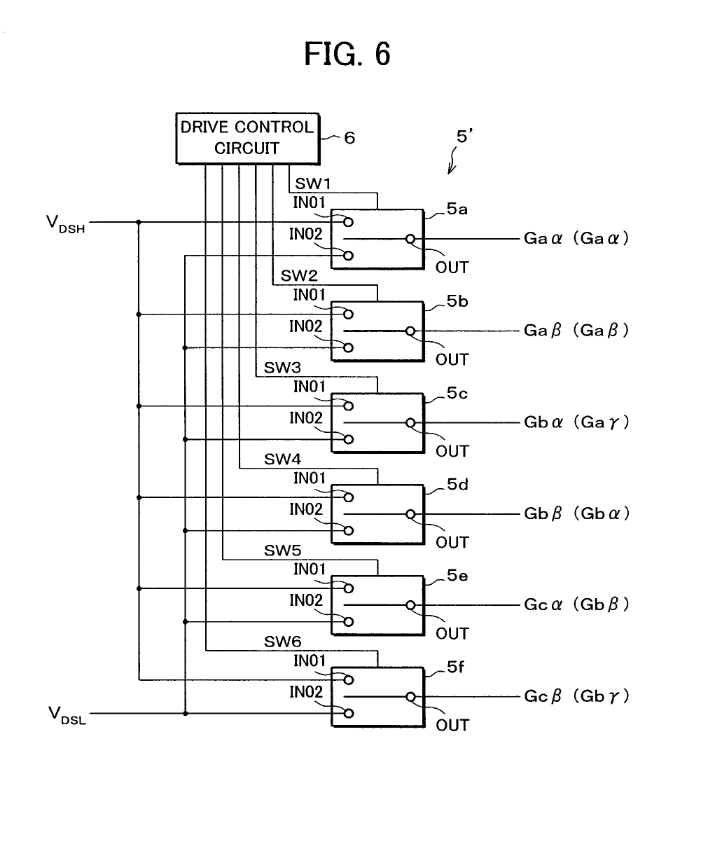

A switching drive circuit 5′ for driving the data line selecting TFTs 13 of the data line switching circuits 8 and 9 can be realized in a manner similar to the above. That is to say, as illustrated in FIG. 6, to the circuit of FIG. 3 which includes 4 level shifter circuits 5a-5d, 2 level shifter circuits 5e and 5f are added so that a circuit with 6 level shifter circuits 5a-5f is realized. For controlling the drive of 2 additional level shifter circuits 5e and 5f, the drive control circuit 6 further supplies switching signals SW5 and SW6.

FIG. 6 illustrates 6 gate lines Gaα-Gbγ of the data line switching circuit 9 of FIG. 5, as gate lines connected to the respective output terminals OUT of the respective level shifter circuits 5a-5f, and the words in parentheses indicate 6 gate lines Gaα-Gbγ of the data line switching circuit 8 illustrated in FIG. 4.

The present embodiment is arranged in such a manner that the data line selecting TFTs 13 connected to one data line DL are in parallel with each other and driven being independent of each other, and only one of these data line selecting TFTs 13 is selected so as to be driven. however, this is merely an embodiment so that the scope of the present invention includes arrangements such as: a plurality of data line selecting TFTs 13 connected to one data line DL in a parallel manner are all simultaneously driven; and some of the data line selecting TFTs 13, which are connected to one data line DL in a parallel manner and can be driven being independent of each other, are selected so as to be simultaneously driven.

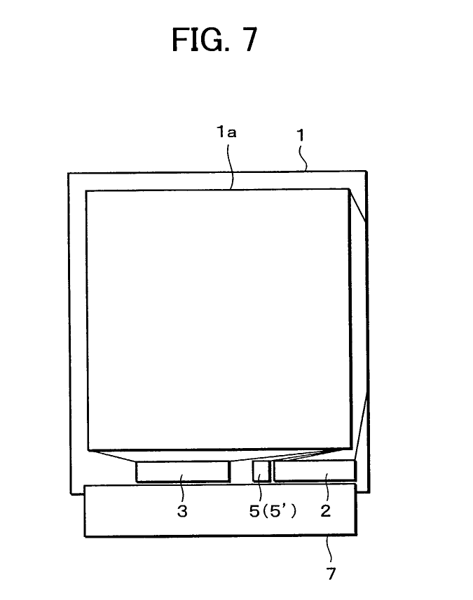

Now, in the equivalent circuit diagram illustrated in FIG. 1, the data line drive circuit 3 is provided along one side of the liquid crystal panel 1, whereas the gate line drive circuit 2 and the switching section drive circuit 5 are provided along a side which is not opposite to the side above. This circuit arrangement is feasible as a matter of course, but in reality, as FIG. 7 illustrates, the liquid crystal display device in accordance with the present embodiment is arranged in such a manner that the data line drive circuit 3, the gate line drive circuit 2, and the switching section drive circuit 5 (5′) are all provided along one of 4 sides of the liquid crystal panel 1.

In the arrangement illustrated in FIG. 7, only one data line drive circuit 3 is required since 2 data lines DL are grouped so as to be connected to one output signal line D of the data line drive circuit 3, while 2 data line drive circuits 3 are required in the arrangement in which one data line DL is connected to one output signal line D of the data line drive circuit 3. On this account, the gate line drive circuit 2 and the switching section drive circuit 5 (5′) are provided in a space where the data line drive circuit 3 is provided in the one-to-one arrangement.

In this manner, since drive circuits such as the data line drive circuit 3 and the gate line drive circuit 2 are provided along one side of the liquid crystal panel 1, it is possible to narrow 3 sides of the frame of a display area 1a, and this enables to effectively enhance the design freedom of the products, compared to the arrangement in which 2 sides of the frames are large in area. Thus the present invention is suitably used for devices such as mobile phones. Incidentally, a member 7 is an FPC to which control signals such as a clock signal and a start pulse signal, data signals, a power supply voltage, and the switching signals SW1-SW4 for controlling the drive of the switching section drive circuit 5 (5′) are supplied.

Moreover, in the arrangement illustrated in FIG. 7, the data line drive circuit 3, the gate line drive circuit 2, and the switching section drive circuit 5 are provided on the matrix substrate on which members such as the data lines DL are formed. The matrix substrate is one of the pair of the substrates constituting the liquid crystal panel 1. In this arrangement, the space for mounting the drive circuits is smaller than that of the arrangement in which the drive circuits are externally added to the liquid crystal panel 1, and this makes it possible to further reduce the size of the frame part. Alternatively, providing only one of the data line drive circuit 3, the gate line drive circuit 2, and the switching circuit 5 (5′) in the manner above also produces a positive effect to some extent.

The data line drive circuit 3, the gate line drive circuit 2, and the switching section drive circuit 5 (5′) provided on the matrix substrate may be manufactured by a driver monolithic method so as to be directly built in the matrix substrate using an LPS, CG silicon, etc., or may be manufactured using LSIs and then mounted on the matrix substrate as TAB or COG.

Alternatively, the switching section drive circuit 5 (5′) may be mounted on the gate line drive circuit 2. The gate line drive circuit 2 includes level shifter circuits for driving the gate lines GL of the pixel TFTs 11. Thus, the switching section drive circuit 5 (5′), which is composed of level shifter circuits for driving the gate lines Ga-GLd of the data line selecting TFTs 13, can be incorporated in the gate line drive circuit 2 without extensive alterations of the manufacturing process.

In this manner, the switching section drive circuit 5 (5′) is incorporated in the gate line drive circuit 2, and this makes it possible to reduce the number of circuits to be provided on the frame part. On this account, the area occupied with the circuits is reduced on the frame part so that the layout of the circuits on the frame part can be flexibly arranged, and consequently the frame part can be downsized. Also in the case of externally attaching drive circuits such as the gate line drive circuit 2 and the gate line drive circuit 3, the arrangement above enables to do away with the process to connect the switching section drive circuit 5 (5′) to the liquid crystal panel 1, and hence it is possible to reduce the manufacturing cost.

When incorporating the switching section drive circuit 5 (5′) in the gate line drive circuit 2, the ON-voltage V_{DSH} and the OFF-voltage V_{DSL} of the data line selection signals may be arranged so as to be equivalent to an ON-voltage V_{GLH} and an OFF-voltage V_{GLL} of the gate signal supplied to the gate lines GL. However, it is preferable that the ON-voltage V_{DSH} and the OFF-voltage V_{DSL} of the data line selection signals are arranged using a power supply line which is exclusively provided for the data line selecting TFTs 13.

With this arrangement, it is possible to keep the ON-voltage V_{DSH} of the data line selecting TFTs 13 lower than the ON-voltage V_{GLH} of the pixel TFTs 11, and consequently the improvement of the reliability of the data line selecting TFTs 13, which are frequently driven, is also realized by lowering the select voltage. Concerning this subject, the following embodiments 2 and 3 will provide detailed descriptions.

[Embodiment 2]

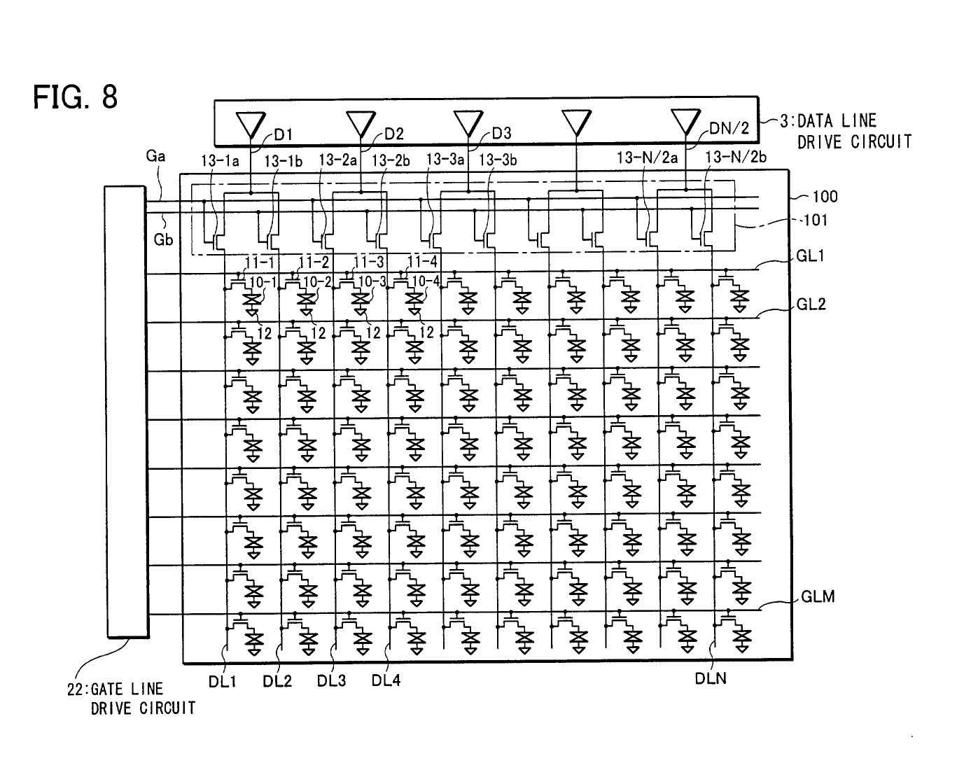

Referring to FIGS. 8 through 14, another embodiment of the present invention will be described below.

FIG. 8 is an equivalent circuit diagram illustrating an active matrix liquid crystal display device in accordance with the present embodiment. In this figure, members having the same functions as those described in FIG. 20 illustrating the background of the invention are given the same numbers.

The first difference between the liquid crystal display device in accordance with the present embodiment illustrated in FIG. 8 and the conventional liquid crystal display device illustrated in FIG. 20 is in a point that while in the liquid crystal display device of FIG. 20, the switching section drive circuit 102 which supplies the data line selection signals to the gate lines Ga and Gb is provided being independently of the gate line drive circuit 200, in the liquid crystal display device illustrated in FIG. 8, the switching section drive circuit, which outputs the data line selection signals to the gate lines Ga and Gb, is incorporated in the gate line drive circuit 22 so that the data line selection signals are outputted from the gate line drive circuit 22. This difference is more specifically described below.

In FIG. 8, a member 100 is a display panel (active matrix display panel). Although not specifically described, the liquid crystal panel 100 includes a matrix substrate, an opposing substrate which faces the matrix substrate with a predetermined distance, and liquid crystal which fills up the space between the substrates.

The matrix substrate is provided with data lines DL1 through DLN running in parallel with each other and gate lines (scanning lines) GL1 through GLM crossing the data lines DL and running in parallel with each other. To each of the gate lines GL, a gate signal is supplied from a gate line drive circuit 22 at the timing corresponding to each of the gate lines GL. The gate signal has an ON-voltage (select voltage) and an OFF-voltage (non-select voltage). To each of the data lines DL, a data signal (image signal) corresponding to each of the data lines DL is supplied from a data line drive circuit 3.

The data lines DL cross the gate lines GL at intersections each provided with a pixel electrode (not illustrated) and a pixel TFT 11. The pixel electrode and an opposing electrode 12 (specifically described below) provided on the opposing substrate form a liquid crystal capacitance 10. This liquid crystal capacitance 10 constitutes a pixel which is a unit of displaying. The pixel TFT 11 is provided for electrically connecting the pixel electrode to the corresponding data line DL, and controlling the writing of the data signal to the pixel electrode. The pixel TFT 11 is arranged in such a manner that the gate electrode thereof is connected to the corresponding gate line GL, the source electrode thereof is connected to the corresponding data line DL, and the drain electrode thereof is connected to the pixel electrode.

In this arrangement, when the gate electrode of the pixel TFT 11 is receiving the ON-voltage from the gate line drive circuit 2 via the gate line GL (writing period), the pixel TFT 11 is in on-state (state of low resistance). When the pixel TFT 11 is in the on-state, the electric potential (voltage) of the data signal supplied from the data line drive circuit 3 to the data line DL is supplied to the pixel electrode, so that the electric potential of the pixel electrode becomes equivalent to the electric potential of the data line DL.

In contrast, when the gate electrode of the pixel TFT 11 is receiving the OFF-voltage from the gate line drive circuit 22 (keep period), the pixel TFT 11 is in off-state (state of high resistance). When the pixel TFT 11 is in the off-state, the electric potential of the pixel electrode is kept to be equivalent to the electric potential at the time of writing.

On the opposing substrate which is the other substrate constituting the liquid crystal panel 100, opposing electrodes 12 are formed. Each of the opposing electrodes 12 is the other electrode constituting the liquid crystal capacitance 10. The opposing electrodes 12 are formed on the entire surface of the opposing substrate, and each of them is provided in each of the pixels in a uniform manner. To these opposing electrodes 12, an appropriate common voltage is supplied from the side of the matrix substrate via common terminals (not illustrated) provided around the matrix substrate.

The liquid crystal capacitance 10 receives a voltage equivalent to the difference (electric potential difference) between the electric potential of the pixel electrode and that of the opposing electrode. The optical transmittance of the liquid crystal is controlled by regulating the voltage supplied to the liquid crystal capacitance 10, and this makes it possible to display images.

The liquid crystal display device in accordance with the present embodiment is also notable for a data line switching circuit 101 which is provided at each of the junctions of the data lines DL formed on the matrix substrate and the respective data line drive circuits 3 driving the corresponding data lines DL.

The data line switching circuit 101 is composed of data line selecting TFTs 13 and input signal lines each connecting a plurality of the data lines DL as a group via the corresponding data line selecting TFTs 13. The data line switching circuit 101 determines which one of the grouped data lines DL receives the signal supplied from the data line circuit 3 via the corresponding output signal line D.

Each of the data lines DL is provided with a data line selecting TFT (switching element) 13 constituting the switching section, and a plurality of the data lines DL are grouped so as to be connected to a common line via the corresponding data line selecting TFTs 13. This common line is connected to the corresponding output signal line D of the data line drive circuit 3. This common line, to which the plurality of the data lines DL are connected via the corresponding data line selecting TFTs 13 which are the switching sections, is an input signal line.

In FIG. 8, 2 data lines DL are paired up as a group. More specifically, a first group of the data lines DL1 and DL2 is connected to an output signal line D1 of the data line drive circuit 3 via respective data line selecting TFTs 13-1a and 13-1b. Similarly, a second group-of the data lines DL3 and DL4 is connected to an output signal line D2 via respective data line selecting TFTs 13-2a and 13-2b. Since the total number N of the data lines DL is 10 in the figure, 5 groups of the paired data lines, a first group to a fifth group, are provided.

Among these 10 data line selecting TFTs 13, type a line selecting TFTs, namely the TFTs 13-1a, 13-2a and 13-3a, connected to the odd-numbered data lines DL, have gate electrodes connected to respective gate lines Ga, and the switching of the gate electrodes is controlled by data line selection signals supplied to the gate line Ga. In the meantime, the type b data line selecting TFTs 13-1b, 13-2b, and 13-3b, connected to the even-numbered data lines DL have gate electrodes connected to respective gate lines Gb, and the switching of the gate electrodes is controlled by the data line selection signals supplied to the gate lines Gb. The data line selection signals supplied to the gate lines Ga and Gb also have an ON-voltage and an OFF-voltage, in the same manner as the gate signals which are scanning signals.

These data line selecting TFTs 13 constituting the data line switching circuit 101 are also formed on the matrix substrate constituting the liquid crystal panel 100 in the same manufacturing process as that of the pixel TFTs 11.

As described above, the liquid crystal display device in accordance with the present embodiment is arranged such that the data line selection signals for driving the data line selecting TFTs 13 of the data line switching circuit 101 are supplied from the gate line drive circuit 22.

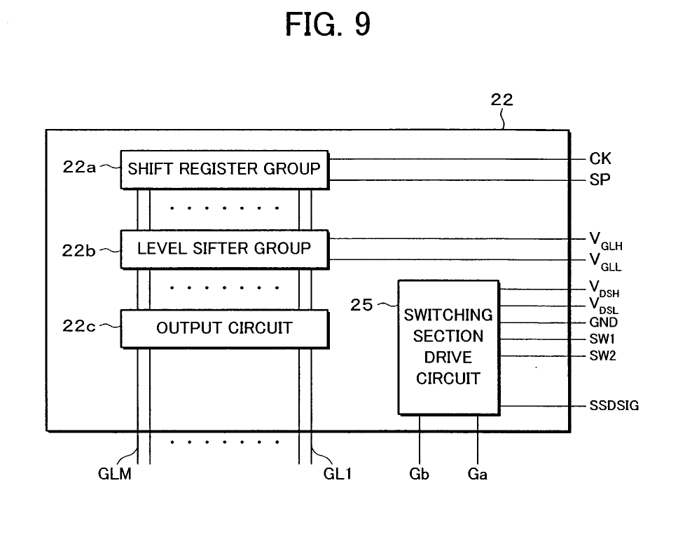

FIG. 9 illustrates an arrangement of the gate line drive circuit 22. In order to supply the gate signals to the gate lines GL, the gate line drive circuit 22 includes a shift register group 22, a level shifter group 22b, an output circuit 22c, and a switching section drive circuit 25 for outputting the data line selection signals.

The shift register group 22a is a circuit for transferring liquid crystal drive output, so at the moment of receiving a start pulse signal SP, a bit 1 signal of the start pulse signal SP is transferred from the shift register group 22a to the outputs to the level shifter group 22b, in accordance with a clock signal CK.

The level shifter group 22b is composed of a plurality of level shifter circuits, and provided for subjecting the liquid crystal drive output signal transferred from the shift register group 22a to level-conversion, so as to convert the liquid crystal drive output signal to an ON-voltage V_{GLH} or the OFF-voltage V_{GLL} which are supplied from the outside of the gate line drive circuit 22.

The output circuit 22c which is composed of an output buffer is a circuit for outputting the liquid crystal drive output which has been subjected to the level-conversion in the level shifter group 22c. From the output circuit 22c, the gate signals for driving the gate lines GL in the liquid crystal panel 1 are outputted.

The gate line drive circuit 22 includes level shifter circuits therein, for driving the gate lines GL of the pixel TFTs 11. Thus, it is possible to incorporate the switching section drive circuit 25, which is also composed of level shifter circuits, into the gate line drive circuit 22 without notable alteration of the manufacturing process of the gate line drive circuit 22.

Since the switching section drive circuit 25 is incorporated into the gate line drive circuit 22 and thus the number of the components is reduced, it is possible to further reduce the area of the frame part occupied with circuits, and this enables to freely arrange the layout of the circuits on the frame part so as to downsize the frame part. Also in the case of externally attaching drive circuits such as the gate line drive circuit 22 and the data line drive circuit 3, the arrangement above enables to do away with the process to connect the switching section drive circuit 25 to the liquid crystal panel 1, and hence it is possible to reduce the manufacturing cost.

Now, when incorporating the switching section drive circuit 25 in the gate line drive circuit 22, the ON-voltage V_{DSH} and OFF-voltage V_{DSL} of the data line selecting TFTs 13 may be arranged so as to be equivalent to the ON-voltage V_{GLH} and the OFF-voltage V_{GLL} of the pixel TFTs 11. However, as illustrated in FIG. 9, in the liquid crystal display device in accordance with the present embodiment, the ON-voltage V_{DSH} and the OFF-voltage V_{DSL} of the data line selecting TFTs 13 are arranged using a power supply line which is exclusively provided for the data line selecting TFTs 13, being independently of the ON-voltage V_{GLH} and OFF-voltage V_{GLL} of the pixel TFTs 11.

This arrangement is adopted to operate the data line selecting TFTs 13 more properly, and to maintain the long-term reliability of the liquid crystal display device by improving the switching property of the data line selecting TFTs 13 of the data line circuit 101.

Since the functions of the pixel TFTs 11 are different from those of the data line selecting TFTs 13, the ON-voltage appropriate for the pixel TFTs 11 is not identical with that for the data line selecting TFTs 13. For instance, the ON-voltage for the pixel TFTs 11 is arranged to be suitable for properly charging the pixel electrodes, whereas the ON-voltage for the data line selecting TFTs 13 is arranged to be suitable for properly supply the data signals from the data line drive circuit 3 to the corresponding data lines DL.

Thus, as in this arrangement, the gate line drive circuit 22 is arranged so as to be capable of having different ON-voltages, and the respective kinds of the TFTs, the pixel TFTs 11 and the data line selecting TFTs 13, have appropriate ON-voltages. On this account, it is possible to drive the data line selecting TFTs 13 in a more appropriate manner.

As a more preferable arrangement, in the present embodiment, the ON-voltage of the data line selection signals is arranged so as to be lower than that of the scanning signals, in order to make the ON-voltage of the pixel TFTs 11 different from that of the data line selecting TFTs 13 (in an absolute value). This makes it possible to raise the reliability of the switching property of the data line selecting TFTs 13 of the data line switching circuit 101, and thus the long-term reliability can be maintained.

That is, TFTs are adopted as the switching elements constituting the data line switching circuit 101, thanks to the advantages such that the TFTs can be manufactured in the same manufacturing process as that of the pixel TFTs 101. However, the frequency of driving the data line selecting TFTs 13 is far greater than the frequency of driving the pixel TFTs 11, and hence normal-sized amorphous TFTs (TFT using amorphous silicon in the semiconductor layer of the channel part) is, despite having enough reliability as the pixel TFTs 11, degraded in its switching characteristics when used as the data line selecting TFTs 13 for a certain amount of time. On this account, a display device adopting the amorphous TFTs is not reliable in the long term.

Incidentally, the long-term reliability of TFTs is easily raised by widening the channel width of the TFTs. However, widening the channel width causes the increase of power consumption. In addition, since the size of the TFTs becomes large, it is necessary to enlarge the size of a matrix substrate on which the TFTs are mounted, and furthermore, a drawing of the output signal (image signal) is caused by the increase of the parasite capacitance. Therefore the method to raise the ling-term reliability of the TFTs by widening the channel width is unfavorable.

To solve this dilemma in relation to the long-term reliability, the liquid crystal display device in accordance with the present invention is provided with a power supply line exclusive for the data line selecting TFTs 13, so that the ON-voltage of the data line selecting TFTs 13 is arranged to be lower than that of the pixel TFTs 11. With this arrangement, the liquid crystal display device of the present embodiment achieves the improvement of the reliability of the data line selecting TFTs 13.

That is to say, while the pixel TFT 11 needs a high ON-voltage for effectively charging the pixel electrodes, the data line selecting TFT 13 is only required to send the data signal, which is supplied from the output signal line D of the data line drive circuit 3, to the data line DL, so that the ON-voltage of the data line selecting TFT 13 is not necessarily as high as the ON-voltage of the pixel TFT 11. The level of ON-voltages in this case is the difference of absolute values, Thus the present embodiment is arranged such that the absolute value of the ON-voltage of the data line selecting TFTs 13 is lower than the absolute value of the ON-voltage of the pixel TFTs 11.

In this embodiment, the OFF-voltage of the data line selecting TFTs 13 is also arranged so as to be different from that of the pixel TFTs 11. However, this arrangement is not mandatory. That is to say, the OFF-voltage of the data line selecting TFTs 13 has to be low enough in order to acquire good switching characteristics, and hence the OFF-voltage of the data line selecting TFTs 13 has to be almost equivalent to that of the pixel TFTs 11.

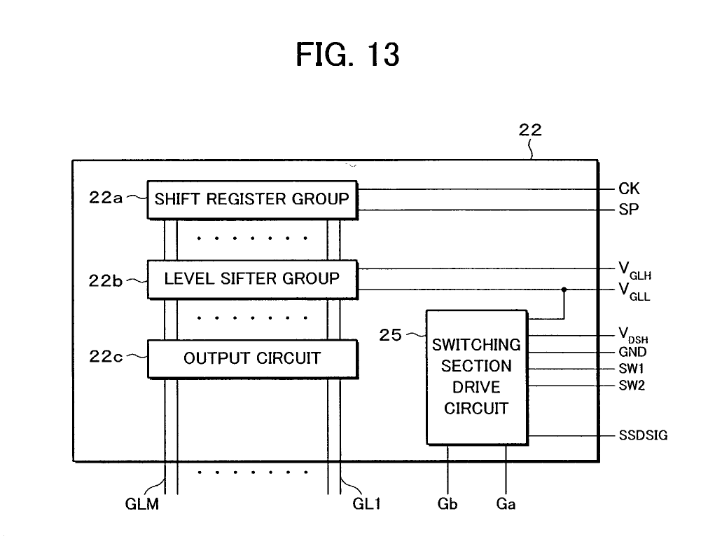

Thus, as in the case of the gate line drive circuit 22 illustrated in FIG. 13, the OFF-voltage of the data line selecting TFTs 13 may be arranged so as to be equal to that of the pixel TFTs 11. This arrangement allows to reduce the number of power supply lines, and this enables to improve the reliability of the connections and raise the flexibility of the layout of the wires. Moreover, since fewer power supply lines are required, it is not necessary to provide an additional circuit for producing the electric power supplied to the lines, and hence the costs can be lowered.

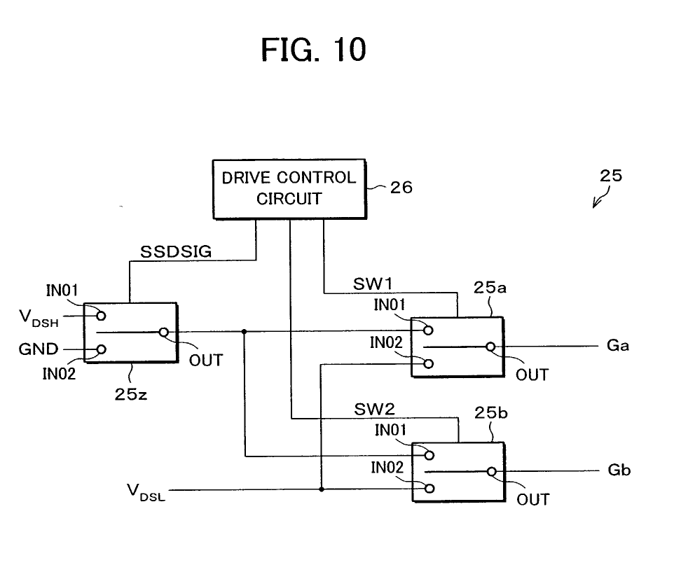

Furthermore, the liquid crystal display device in accordance with the present invention has an arrangement such that, as illustrated in FIG. 10, a level shifter circuit 25z is provided in the switching section drive circuits, in order to take a period when an intermediate voltage which is a voltage between the ON-voltage and the OFF-voltage is supplied at the time of switching the data line selecting TFTs 13.

FIG. 10 illustrates an arrangement of the switching section drive circuit 25 provided inside the gate line drive circuit 22.

The switching section drive circuit 25 is provided with: 2 level shifter circuits 25a and 25b whose output terminals OUT are connected to the gate lines Ga and Gb respectively; and the level shifter circuit 25z whose output terminal OUT is connected to the first output terminals IN01 of the respective level shifter circuits 25a and 25b.

The level shifter circuit 25z receives a control signal SSDSIG from the drive control circuit 26. The supplied control signal SSDSIG is a signal for setting a period when the data line selecting TFTs 13 have the ON-voltage V_{DSH}, so as to be converted to either the ON-voltage VDSH of the data line selecting TFTS 13, which is supplied to a first input terminal IN01 of the level shifter circuit 25z, or the intermediate electric potential supplied to a second input terminal IN02 of the level shifter circuit 25z. In this case, the intermediate electric potential is equivalent to the GND level. The converted output is supplied to the input terminals IN01 of the respective level shifter circuits 25a and 25b connected to the output terminal IN01 of the level shifter circuit 25z, from the output terminal OUT of the level shifter circuit 25z.

The level shifter circuit 25a and 25b receive the switching signals SW1 and SW2 respectively, from the drive control circuit 26. The supplied switching signal SW1 is subjected to level-conversion so as to be converted to the output voltage (ON-voltage V_{DSH} or the GND level) supplied from the level shifter 25z to first input terminals of the respective level shifter circuits 25a and 25b, whereas the supplied switching signal SW2 is subjected to level conversion so as to be converted to the OFF-voltage V_{DSL} of the data line selecting TFTs 13, supplied to the second input terminals IN02 of the respective level shifter circuits 25a and 25b. The converted outputs are supplied to the respective gate lines Ga and Gb connected to the corresponding output terminals OUT, so as to be outputted as the data line selection signals.

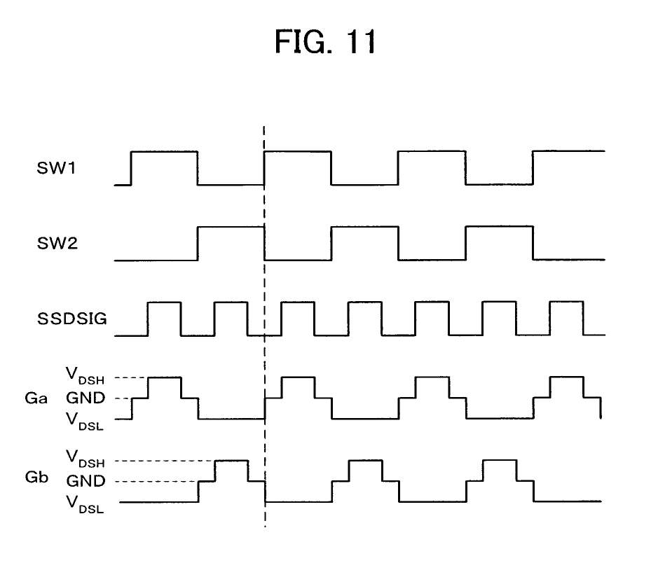

FIG. 11 illustrates waveforms of the switching signals SW1 and SW2, the control signal SSDSIG, and the data line selection signals outputted to the respective gate lines Ga and Gb.

The data line selection signals which are drive signals controlling the type a data line selecting TFTs 13 are the switching signal SW1 supplied to the level shifter circuit 25a and the control signal SSDSIG supplied to the level shifter 25z, and these signals have a period to be the GND level at the time of switching from the ON-voltage to the OFF-voltage and at the time of switching from the OFF-voltage to the ON-voltage.

Similarly, the data line selection signals which are drive signals for controlling the type b data line selecting TFTs 13 are the switching signal SW2 supplied to the level shifter circuit 25b and the control signal SSDSIG supplied to the level shifter 25z, and these signals have a period to have the GND level at the time of switching from the ON-voltage to the OFF-voltage and at the time of switching from the OFF-voltage to the ON-voltage.

In an arrangement without the period of the intermediate voltage, at the time of voltage increase from the OFF-voltage to the ON-voltage or at the time of voltage decrease from the ON-voltage to the OFF-voltage, the electric power is supplied so that the electric potential is promptly increased or decreased. On this account, the power consumption of this arrangement is greater than that of the arrangement adopting the period of the intermediate voltage at the time of switching the voltage level, so especially the data line selecting TFTs 13 which are frequently driven consume a large amount of electricity in this arrangement.

In contrast, the liquid crystal display device in accordance with the present embodiment has the period of the intermediate voltage (GND level in this case) at the time of switching the voltage level, and thus, at the time of voltage increase, the voltage is increased from the OFF-voltage to the GND level by free discharging and the voltage is increased from the GND level to the ON-voltage by the supply of electric power, while at the time of voltage decrease, the voltage is decreased from the ON-voltage to the GND level by free discharging and the voltage is decreased from the GND level to the OFF-voltage by the supply of electric power. With this arrangement, it is possible to decrease the power consumption.

Moreover, since the intermediate voltage in the present embodiment is equivalent to the GND level, it is possible to reduce the power consumption due to the current flowing towards the intermediate voltage, so that the power consumption can be reduced in a extremely effective manner.

To reduce the power consumption due to the current flowing towards the intermediate voltage, it is preferable that the impedance of the power supply for generating the intermediate voltage is as low as possible. However, even through a normal power supply (for instance a positive power supply or a negative power supply) has impedance lower than the impedances of other signal lines, this does not indicate that the impedance of the power supply is the lowest in the whole system. In the meantime, the GND is a reference voltage for producing a circuit power supply so that the impedance of the GND is very low compared with the impedances of other voltages (generally the lowest in the whole system). Thus, if the intermediate voltage is equivalent to the GND level, the power consumption owing to the current flowing towards the intermediate voltage can be reduced.

Furthermore, as illustrated in FIG. 11, since it does not happens that both the data line selection signals supplied to the data line Ga and the data line selection signals supplied to the data line Gb have the ON-voltage, a single control signal SSDSIG, which is supplied to the level shifter circuit 25z and determines the period of ON-voltage, changes the voltage supplied to the input terminals IN01 of the respective level shifter circuits 25a and 25b from the ON-voltage V_{DSH} to the GND level and vice versa, so that the period when the data line selection signals of the types a and b both have the intermediate voltage is arranged.

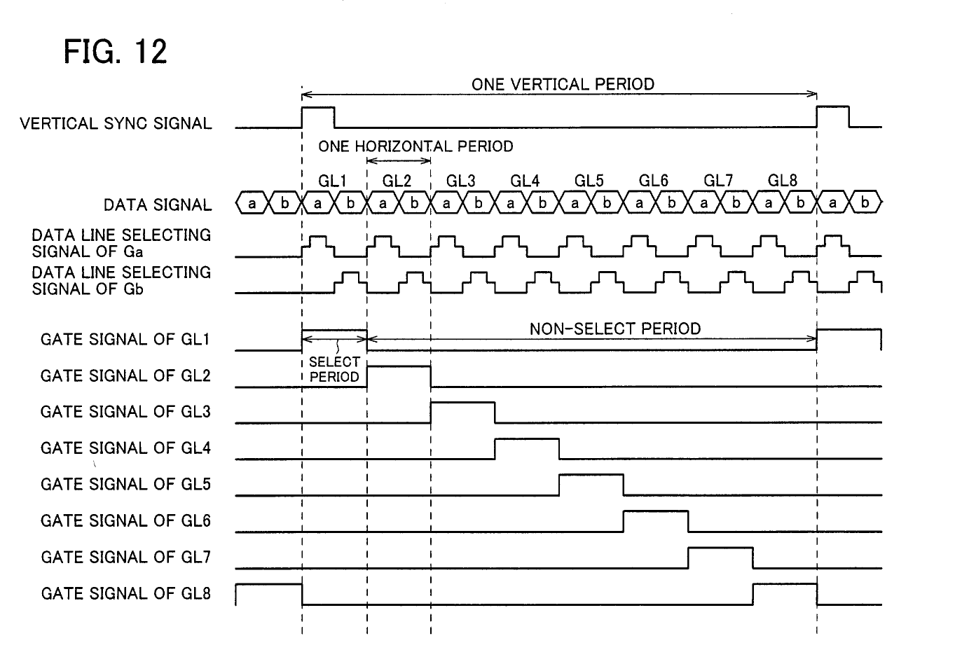

FIG. 12 illustrates waveforms of drive signals (vertical sync signals, data signals, data line selection signals supplied to the gate lines Ga and Gb, and gate signals supplied to the gate lines GL1-GLM) supplied to the liquid crystal panel 100 of the aforementioned liquid crystal display device. Here, the pixel TFTs 11 and the data line selecting TFTs 13 are turned on with a positive voltage as in the case of n-channel FETs, and the total number M of the gate lines GL is 8.

As illustrated in FIG. 12, in this liquid crystal display device, one horizontal period, over which the ON-voltage is supplied to the gate lines GL, consists of 2 phases. In each of the phases, the data line selection signals, having the period of the intermediate voltage and supplied to the gate lines Ga and Gb, turn on either one type of data line selecting TFTs 13, type a or type b, of the data line switching circuit 101. Thus, among all of the data lines DL, only the data lines DL connected to the data line selecting TFTs 13 which have been turned on receive the data signals from the data line drive circuit 3, so that the data signals are written in the pixel electrodes connected to these data line DL.

Here, although 2 data lines DL2 are grouped so as to be connected to one output of the data line drive circuit 3 in the present embodiment, the number of the data lines DL to be grouped is not necessarily 2.

Also, the arrangement to keep down the power consumption due to the switching of the switching TFTs 13 by arranging the intermediate voltage period is not limited to be applied for the arrangement in which the switching section drive circuit 25 is incorporated in the gate line drive circuit 22 as in the case of the liquid crystal display device of the present embodiment. Therefore, as a matter of course, it is possible to acquire the same effect from an arrangement in which the switching section drive circuit 25 is provided separately from the gate line drive circuit 22.

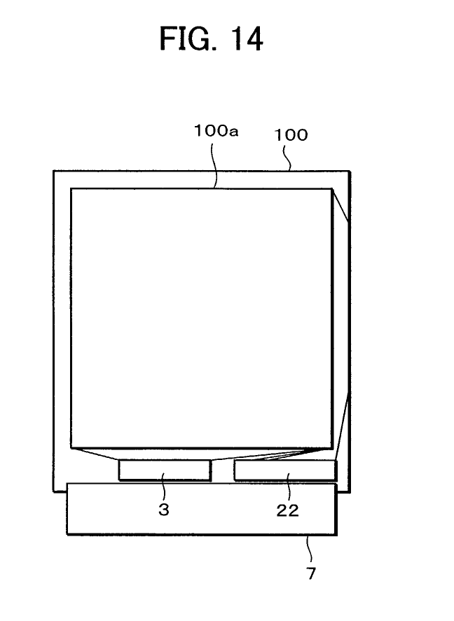

In the description above, the arrangement in which the data line drive circuit 3 and the gate line drive circuit 22 in which the switching section drive circuit 25 is incorporated are provided along 2 non-opposing sides of the liquid crystal panel 100 is illustrated referring to the equivalent circuit diagram of FIG. 8. This arrangement is feasible as a matter of course, however, in reality the liquid crystal panel 100 is provided with the data line drive circuit 3 and the gate line drive circuit 22 along one of 4 sides of the panel, as illustrated in FIG. 14.

In the arrangement illustrated in FIG. 14, only one data line drive circuit 3 is required thanks to the connection of 2 data lines DL to one output signal line D of the data line drive circuit 3, compared with the arrangement in which one data line DL is connected to one output signal line D of the data line drive circuit 3 so as to require 2 data line drive circuit 3. For this reason, in the arrangement of FIG. 14, the gate line drive circuit 22 is provided in a space where the data line drive circuit 3 is provided in the case of the one-to-one connection of the data line DL and the output signal line D.

In this manner, since drive circuits such as the data line drive circuit 3 and the gate line drive circuit 22 are provided along one side of the liquid crystal panel 100, it is possible to narrow 3 out of 4 sides of the frame part of the display area 100a, and this enables to effectively enhance the design freedom of the products, compared to the arrangement in which 2 sides of the frames are large in area. Thus the present invention with this arrangement is suitably used for devices such as mobile phones. Incidentally, a member 7 in the figure is an FPC to which control signals such as a clock signal and a start pulse signal, data signals, a power supply voltage, the switching signals SW1 and SW2 for controlling the drive of the switching section drive circuit 5, and the control signal SSDSIG are supplied.

In the arrangement illustrated in FIG. 14, the data line drive circuit 3 and the gate line drive circuit 22 are provided on the matrix substrate on which the data line DL, etc. are formed, the matrix substrate being one of two panels constituting the liquid crystal panel 100. With this arrangement, it is possible to reduce the space for mounting the drive circuits so as to further downsize the frame part, compared to the arrangement of externally providing the drive circuits to the liquid crystal panel 100. Alternatively, providing only either one of the data line drive circuit 3 and the gate line drive circuit 22 in the manner above also produces a positive effect to some extent.

The data line drive circuit 3 and the gate line drive circuit 22 which are provided on the matrix substrate may be manufactured by a driver monolithic method so as to be directly built in the matrix substrate using an LPS, CG silicon, etc., or may be manufactured using LSIs and then mounted on the matrix substrate as TAB or COG.

[Embodiment 3]

What is described in this embodiment is an active matrix display device which is arranged in such a manner that the arrangement, in which each of the switching sections of the data line switching circuit is composed of a plurality of the switching elements as described in Embodiment 1, is combined with the arrangement in which one gate line drive circuit capable of having different ON-voltages so that the ON-voltage of the data line selection signals for driving the switching sections is different from the ON-voltage of the gate signals for driving the pixel switches as described in Embodiment 2.

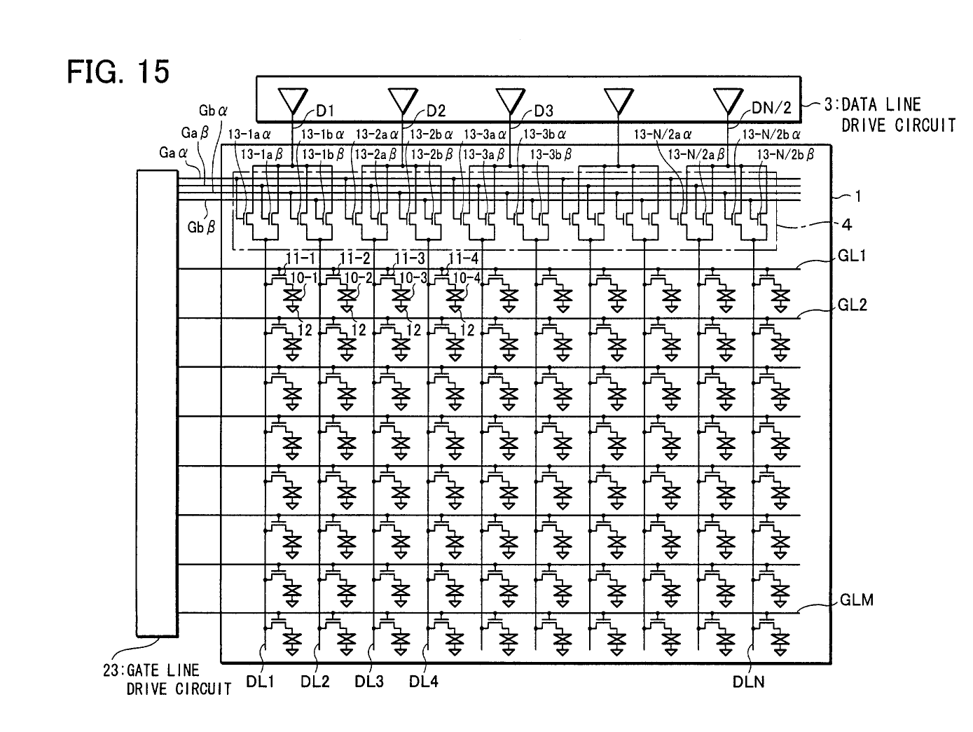

Referring to FIGS. 15 through 19, a further embodiment in accordance with the present invention is described as below. By the way, members having the same functions as those described in Embodiments 1 and 2 are given the same numbers, so that the descriptions are omitted for the sake of convenience.

FIG. 15 is an equivalent circuit diagram illustrating an arrangement of an active matrix liquid crystal display device in accordance with the present embodiment.

As the figure shows, the liquid crystal display device in accordance with the present embodiment includes the data line switching circuit 4 provided in the liquid crystal display device of Embodiment 1 illustrated in FIG. 1, instead of the data line switching circuit 101 of the liquid crystal display device of Embodiment 2 illustrated in FIG. 8. In other words, in the liquid crystal display device in accordance with the present embodiment, the liquid crystal display device of FIG. 8 is provided with the liquid crystal panel 1 of FIG. 1 instead of the liquid crystal panel 100, and in a gate line drive circuit 23, a switching section drive circuit 35 is provided instead of the switching section selection drive circuit 25. This switching section drive circuit 35 is arranged in such a manner that a switching section drive circuit 5 for driving the switching sections of the data line switching circuit 4 has a power supply line which is exclusive for the data line selecting TFTs 13 and capable of having an intermediate electric potential. Apart from this, the arrangement of the liquid crystal display device of the present embodiment is identical with that of the liquid crystal display device of Embodiment 2.

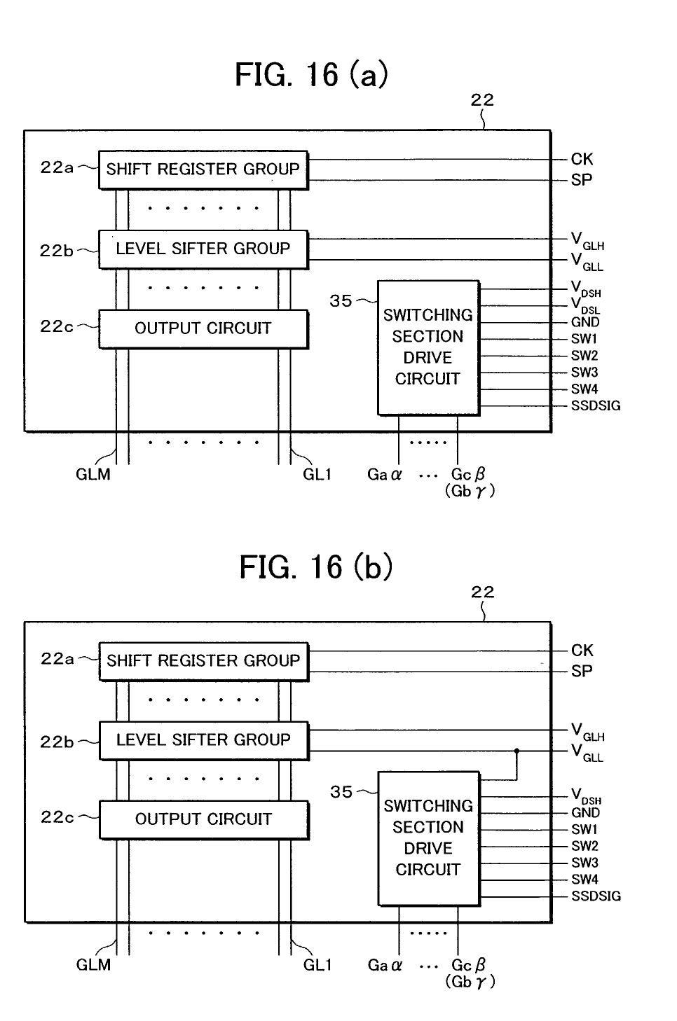

The respective FIGS. 16(a) and 16(b) show 2 types of gate line drive circuits 23 with a switching section drive circuit 35 having a power supply line exclusively for the data line selecting TFTs 13, each of which is capable of having an intermediate electric potential. As described above, the ON-voltage V_{DSL} of the data line selecting TFTs 13 may be arranged differently from the OFF-voltage VGLL of the pixel TFTs 11 as in the arrangement shown in FIG. 16(a), or these two voltages may be arranged in an identical manner as in the arrangement shown in FIG. 16(b).

In this manner, the liquid crystal display device in accordance with the present embodiment is arranged such that: the data line switching circuit 4 is provided therein, each of the switching sections provided between the output signal lines D of the data line drive circuit 3 and the corresponding data lines DL is composed of a plurality of the data line selecting TFTs 13; and the switching section drive circuit 35 incorporated in the data line drive circuit 23 has a power supply line which is exclusively for the data line selecting TFTs 13.

With this arrangement, the effect of improving the long-term reliability of the data line selecting TFTs 13 in Embodiment 1 is synergistically combined with the effect in Embodiment 2, and hence it is possible to effectively maintain the long-term reliability of the switching characteristics of the data line selecting TFTs 13, so as to further improve the long-term reliability of the liquid crystal display device, compared with the case when only either one of these two arrangements is adopted. Moreover, in addition to the arrangement of providing the power supply line exclusively for the data line selecting TFTs 13, the intermediate electric potential can be arranged in the present embodiment so that the power consumption is further restrained.

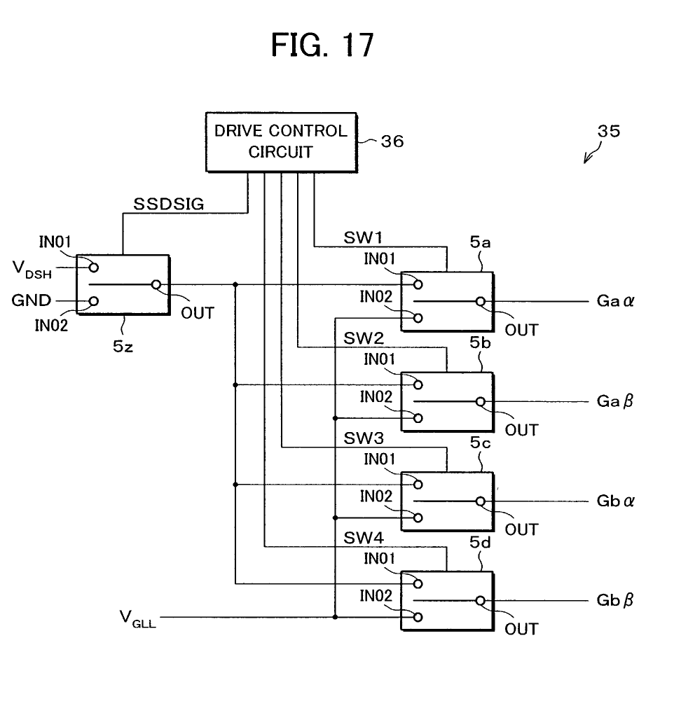

FIG. 17 illustrates an arrangement of the switching section drive circuit 35 which outputs the data line selection signals to the gate lines Gaα and Gbβ.

The switching section drive circuit 35 is composed of: 4 level shifter circuits 5a-5d whose output terminals OUT are connected to the respective gate lines Gaα-Gaβ; and a level shifter circuit 5z whose output terminal OUT is connected to input terminals IN01 of the respective level shifter circuits 5a-5d.

The level shifter circuit 5z receives a control signal SSDSIG from a drive control circuit 36. The supplied control signal SSDSIG is subjected to level-conversion so as to be converted either to an ON-voltage V_{DSH} of the data line selecting TFTs 13, which is supplied to an input terminal IN01 of the level shifter circuit 5z, or an intermediate electric potential (equivalent to the GND level in this case) supplied to a second input terminal IN02 of the level shifter circuit 5z. The converted outputs are supplied from the output terminal OUT of the level shifter circuit 5z to first input terminals IN01, which are connected to the output terminal OUT above, of the respective level shifter circuits 5a-5d.

The level shifter circuits 5a-5d receive respective switching signals SW1-SW4 from the drive control circuit 36. These switching signals SW1-SW4 are subjected to level-conversion so as to be converted either to the output voltage (ON-voltage V_{DSH} or the GND level) supplied from the level shifter circuit 5z to the first input terminals IN01 of the respective level shifter circuits 5a-5d or an OFF-voltage V_{DSL} of the data line selecting TFTs 13, which is supplied to the aforementioned second input terminals IN02. As data line selection signals, the converted outputs are supplied from the output terminals OUT of the respective level shifter circuits 5a-5d to the gate lines Gaα-Gbβ connected to the respective output terminals OUT.

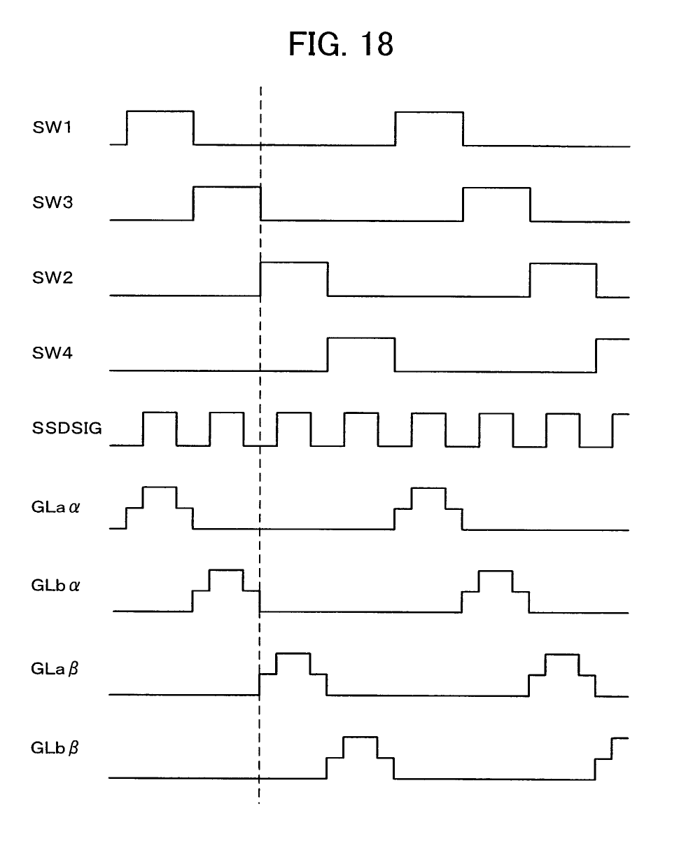

FIG. 18 illustrates waveforms of the signals in the switching section drive circuit 35, namely the switching signals SW1-SW4, the control signal SSDSIG, and the data line selection signals supplied to the data lines DLaα-DLbβ.

A data line selection signals which is a drive signal for controlling type a(α) data line selecting TFTs 13 and supplied to the gate line Gaα, is converted from the ON-voltage to the off voltage or from the OFF-voltage to the ON-voltage by the switching signal SW1 supplied to the level shifter circuit 5a and the control signal SSDSIG supplied to the level shifter 5z, and at the time of the conversion, the data line selection signals becomes a signal with a period of the GND level.

A data line selection signals which is a drive signal for controlling type b(α) data line selecting TFTs 13 and supplied to the gate line Gbα, is converted from the ON-voltage to the off voltage or from the OFF-voltage to the ON-voltage by the switching signal SW2 supplied to the level shifter circuit 5b and the control signal SSDSIG supplied to the level shifter 5z, and at the time of the conversion, the data line selection signals becomes a signal with a period of the GND level.

A data line selection signals which is a drive signal for controlling type a(β) data line selecting TFTs 13 and supplied to the gate line Gaβ, is converted from the ON-voltage to the off voltage or from the OFF-voltage to the ON-voltage by the switching signal SW1 supplied to the level shifter circuit 5a and the control signal SSDSIG supplied to the level shifter 5z, and at the time of the conversion, the data line selection signals becomes a signal with a period of the GND level.

A data line selection signals which is a drive signal for controlling type b(β) data line selecting TFTs 13 and supplied to the gate line Gbβ, is converted from the ON-voltage to the off voltage or from the OFF-voltage to the ON-voltage by the switching signal SW4 supplied to the level shifter circuit 5d and the control signal SSDSIG supplied to the level shifter 5z, and at the time of the conversion, the data line selection signals becomes a signal with a period of the GND level.

As described above, 2 data lines DL connected to one output signal line D are not simultaneously driven, and in each of 2 phases constituting a period (horizontal period) when the ON-voltage is being applied to the gate lines GL, either one type of the data line selecting TFTs 13 of the data line switching circuit 4, i.e. the type a or the type b, are turned on. In this case, the type a data line selecting TFTs 13 are composed of 2 type a(α) TFTs and 2 type a(β) TFTs, and the type b data line selecting TFTs 13 are also composed of 2 type b(α) TFTs and 2 type b(β) TFTs. Thus, in a phase when the type a TFTs are selected, either type a(α) TFTs or type a(β) TFTs are selected, while in a phase when the type b TFTs are selected, either type b(α) TFTs or type b(β) TFTs are selected.

Then, as FIG. 18 illustrates, since it does not happen that the data line selection signals supplied to the respective data lines Gaα-Gbβ simultaneously have the ON-voltage, one control signal SSDSIG, which is supplied to the level shifter circuit 5z and determines the period of the ON-voltage, switches the voltage, which is supplied to the first input terminals IN01 of the respective level shifter circuits 5a-5d, from the ON-voltage V_{DSH} to the GND level or from the GND level to the ON-voltage V_{DSH}. On this account, the period of the intermediate voltage is arranged in each of 4 types of the data line selection signals, type a(α) to type b(β).

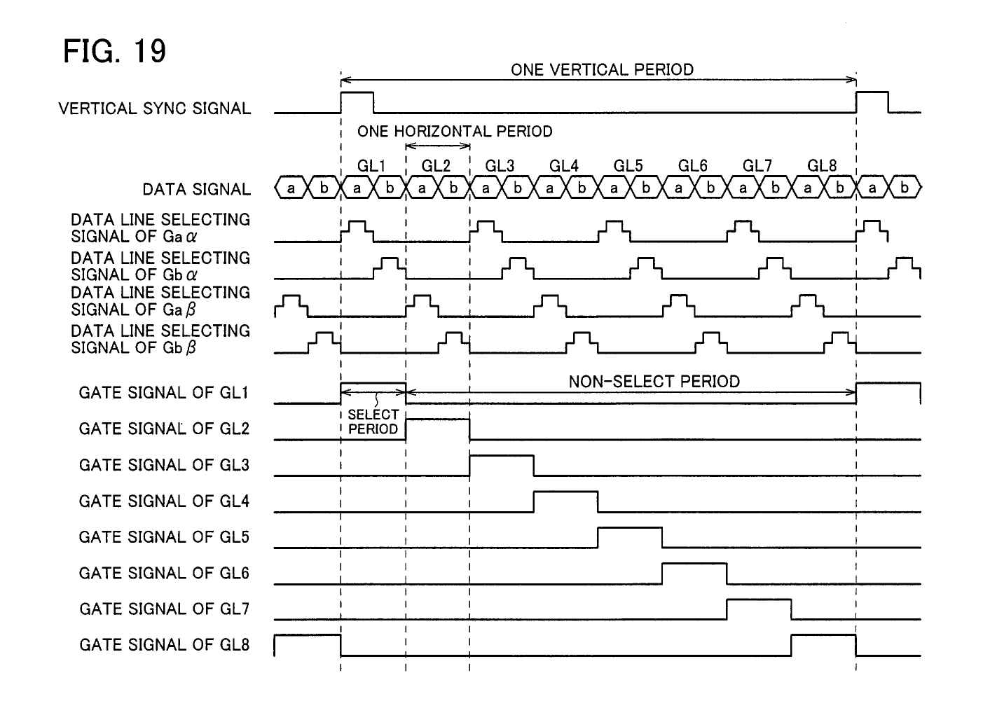

FIG. 19 illustrates waveforms of drive signals (vertical sync signals, data signals, data line selection signals supplied to the gate lines Gaα-Gbβ, and gate signals supplied to the gate lines GL1-GLM) supplied to the liquid crystal panel 1 of the aforementioned liquid crystal display device. Here, the pixel TFTs 11 and the data line selecting TFTs 13 are turned on with a positive voltage as in the case of n-channel FETs, and the total number M of the gate lines GL is 8.

The arrangement illustrated in FIG. 19 is basically identical with the arrangement of Embodiment 1 illustrated in FIG. 3 except the point that the ON-voltage of the data line selection signals has the intermediate electric potential, so that further descriptions thereof are not provided.

Also, it goes without saying that the alternative arrangements of the liquid crystal display device as described in Embodiments 1 and 2 are also applicable to the liquid crystal display device of Embodiment 3.

As described above, in a data line switching circuit of an active matrix display panel of the present invention, having a scanning line and a plurality of data lines which are crossed with the scanning line,

the data line switching circuit, includes:

switching sections which are provided for the respective data lines on a signal input side of the data lines; and

input signal lines each of which combines the data lines as one group via the respective switching sections,

wherein the switching sections for the respective data lines as one group are caused to drive alternatively so that a data signal inputted from the input signal line is supplied to one of the data lines as one group, and

each of the switching section is composed of a plurality of switching elements which are connected in parallel to each other.

Therefore, properly driving the plurality of elements which construct the switching section makes it possible to increase a long-term reliability, thereby obtaining a long-term reliability, as compared with the conventional switching section having an arrangement of one element.

As compared with an arrangement of the switching section having one element increased in size for increasing a long-term reliability of the switching section, such an arrangement of the switching section having the plurality of elements can reduce an area occupied with one switching section in case where the same level of long-term reliability can be obtained, so that it is possible to increase a long-term reliability without inhibiting a reduction in the area of the frame part and a downsizing of the active matrix display panel.

As described above, in the data line switching circuit of the present invention, the plurality of switching elements constructing the switching section are capable of driving independently from each other, and are caused to drive selectively in a period during which the switching section is caused to drive.

As to a plurality of elements connected in parallel to each other, an arrangement in which all of the elements are driven simultaneously can be considered. In such a case, all of the plurality of elements are driven simultaneously. When one of them breaks down, the rest of the elements can output the signal to the data line to which the switching section is connected. However, in such a case, the plurality of elements are driven, increasing an electric power required for driving the switching sections.

In the above arrangement of the present invention, the plurality of elements constructing the switching section are provided so as to be driven independently from each other. In the period during which the switching section is driven, one or some elements selected from the plurality of elements constructing the switching section are caused to drive, so that it is possible to reduce an electric power required for driving the switching section, as compared with the arrangement in which all of the elements constructing the switching section are caused to drive in the period during which the switching section is selectively driven.

That is, the switching section which is composed of a plurality of elements connected in parallel to each other can increase a long-term reliability and restrain a power consumption without increasing the area occupied with the switching section, by causing the plurality of elements to drive properly, as compared with the conventional switching section arranged with one element.

Further, as described above, in the data line switching circuit of the present invention, the plurality of switching elements constructing the switching section can be caused to drive so that a driving frequency equals between the switching elements.

In the case where the plurality of elements constructing the switching section are driven selectively, particular elements taking priority over the other elements are driven, which causes variation of a frequency in use of elements, so that the particular elements might break down earlier than the other elements.

In the above arrangement of the present invention, when the plurality of elements constructing the switching section are selectively driven, they are caused to drive so that a driving frequency equals between the elements, so that it is possible to use the elements constructing the switching section equally and to equalize the life duration of the elements, thereby effectively extending a long-term reliability.

That is, the switching section which is composed of a plurality of elements connected in parallel to each other can increase a long-term reliability, reduce a power consumption, and use the plurality of elements most effectively by causing the plurality of elements to drive properly, thereby further increasing the long-term reliability, without increasing the area occupied with the switching section, as compared with the conventional switching section arranged with one element.

Further, as described above, in the data line switching circuit of the present invention, the switching sections for the respective data lines as one group are caused to drive one by one at a cycle of H/X, where X is a number of the data lines as one group, and H is one horizontal period in which a select voltage is applied to the scanning line.

Thus, the switching sections for the respective data lines as one group are caused to drive one by one at a cycle of H/X, which is a period found by division of one horizontal period H by the number of the data lines X. This makes it possible to input the data signal to one of the data lines as one group and to display images in an ON-period during which select voltage is applied to the scanning line.

In a switching section drive circuit of the present invention which alternatively drives switching sections in a data line switching circuit of an active matrix display panel in accordance with drive signals supplied from a drive control circuit so that a data signal inputted from the input signal line is supplied to one of a plurality of data lines as one group,

a plurality of switching elements are caused to drive selectively in a period during which the switching sections are caused to drive.

Such a switching section drive circuit in which driving of the switching sections in the data line switching circuit is controlled provides the arrangement of the switching section in which a plurality of elements are connected in parallel to each other, as previously described as the data line switching circuit. By causing the plurality of elements to drive properly, it is possible to increase a long-term reliability without increasing the area occupied with the switching section and a power consumption, as compared with the conventional switching section arranged with one element.

Further, in the switching section drive circuit of the data line switching circuit of the present invention, the plurality of switching elements constructing the switching section can be caused to drive so that a driving frequency equals between the switching elements.

According to this arrangement, when the plurality of elements constructing the switching section are selectively driven, they are caused to drive so that a driving frequency equals between the elements, so that it is possible to use the elements constructing the switching section equally and to equalize the life duration of the elements, thereby extending a long-term reliability more effectively.

Further, in the switching section drive circuit of the data line switching circuit of the present invention, it is arranged so that the switching sections for the respective data lines as one group are caused to drive, in accordance with drive signals supplied from a drive control circuit, one by one at a cycle of H/X, where X is a number of the data lines as one group, and H is one horizontal period in which a select voltage is applied to the scanning line.

By controlling the driving of the switching sections of the data line switching circuit in such a switching section drive circuit, it is possible to input the data signal to one of the data lines as one group and to display images in an ON-period during which select voltage is applied to the scanning line, as previously described as the data line switching circuit.

In a drive control circuit of the data line switching circuit of the present invention which is a drive control circuit for outputting drive signals to a switching section drive circuit, the plurality of switching elements constructing the switching section are caused to drive selectively in a period during which the switching section is caused to drive.

Such a drive control circuit in which driving of the switching sections in the data line switching circuit is controlled provides the arrangement of the switching section in which a plurality of elements are connected in parallel to each other, as previously described as the data line switching circuit. By causing the plurality of elements to drive properly, it is possible to increase a long-term reliability without increasing the area occupied with the switching section and a power consumption, as compared with the conventional switching section arranged with one element.

Further, in the drive control circuit of the data line switching circuit of the present invention, the plurality of switching elements constructing the switching section can be arranged so that a driving frequency equals between the switching elements.

According to this arrangement, when the plurality of elements constructing the switching section are selectively driven, they are caused to drive so that a driving frequency equals between the elements, so that it is possible to use the elements constructing the switching section equally and to equalize the life duration of the elements, thereby extending a long-term reliability more effectively.

Further, in the drive control circuit of the data line switching circuit of the present invention, it is arranged so that the switching sections for the respective data lines as one group are caused to drive one by one at a cycle of H/X, where X is a number of the data lines as one group, and H is one horizontal period in which a select voltage is applied to the scanning line.

By controlling the driving of the switching sections of the data line switching circuit via the switching section drive circuit in such a switching section drive circuit, it is possible to input the data signal to one of the data lines as one group and to display images in an ON-period during which select voltage is applied to the scanning line, as previously described as the data line switching circuit.

In an active matrix display panel of the present invention, having a scanning line and a plurality of data lines which are crossed with the scanning line,

a data line switching circuit, includes:

switching sections which are provided for the respective data lines on a signal input side of the data lines; and

input signal lines each of which combines the data lines as one group via the respective switching sections,

the switching sections for the respective data lines as one group being caused to drive alternatively so that a data signal inputted from the input signal line is supplied to one of the data lines as one group,

each of the switching section being composed of a plurality of switching elements which are connected in parallel to each other.

Such an active matrix display panel provides the arrangement of the switching section in which a plurality of elements are connected in parallel to each other, as previously described as the data line switching circuit. By causing the plurality of elements to drive properly, it is possible to increase a long-term reliability, as compared with the conventional switching section arranged with one element.

Further, as described above, in the active matrix display panel of the present invention, the plurality of switching elements constructing the switching section are capable of driving independently from each other, and are caused to drive selectively in a period during which the switching sections are caused to drive.

Such an active matrix display panel provides the arrangement of the switching section in which a plurality of elements are connected in parallel to each other, as previously described as the data line switching circuit. By causing the plurality of elements to drive properly, it is possible to increase a long-term reliability without increasing the area occupied with the switching section and a power consumption, as compared with the conventional switching section arranged with one element.

Further, the active matrix display device of the present invention, includes:

an active matrix display panel having the above arrangement;

a data line drive circuit for outputting to the data lines data signals in accordance with the respective data lines; and

a scanning line drive circuit for outputting gate signals each having a select voltage and a non-select voltage to the scanning line at a timing in accordance with the scanning line.

Further, the active matrix display device of the present invention, includes:

(a) an active matrix display panel having the above arrangement;

(b) a data line drive circuit for outputting to the data lines data signals in accordance with the respective data lines;

(c) a scanning line drive circuit for outputting gate signals each having a select voltage and a non-select voltage to the scanning line at a timing in accordance with the scanning line,

(d) a drive control circuit for outputting the drive signals for selecting and driving the plurality of switching elements constructing the switching section of the data line switching circuit in the active matrix display panel in a period during which the switching sections are selected and caused to drive; and

(e) a switching section drive circuit for driving the plurality of switching elements in the data line switching circuit in accordance with the drive signals supplied from the drive control circuit.

Such an active matrix display device provides the arrangement of the switching section in which a plurality of elements are connected in parallel to each other, as previously described as the data line switching circuit. By causing the plurality of elements to drive properly, it is possible to increase a long-term reliability without increasing the area occupied with the switching section and a power consumption, as compared with the conventional switching section arranged with one element.

Further, in the active matrix display device of the present invention, the switching section drive circuit is mounted in the scanning line drive circuit.

By mounting the switching section drive circuit in the scanning line drive circuit, it is possible to reduce the number of circuit components, which reduces costs according to the reduction in the number of the circuit components, reduces the area occupied with the circuit components on the frame part. This makes it possible to easily arrange a layout of circuits, thereby increasing a degree of flexibility in design and reducing the area of the frame part more effectively.

Further, in the active matrix display device of the present invention, at least any one of the data line drive circuit, the scanning line drive circuit, and the switching section drive circuit is provided on a substrate which is the same as a substrate constructing the active matrix display panel.

Incorporating at least any one of the data line drive circuit, the scanning line drive circuit, or the switching section drive circuit into the substrate of the panel can eliminate a space for mounting. This makes it possible to arrange a layout of circuits easily, thereby increasing a degree of flexibility in design and reducing the area of a frame part more effectively.

Further, in the active matrix display device of the present invention, the switching sections for the respective data lines as one group are caused to drive one by one at a cycle of H/X, where X is a number of the data lines as one group, and H is one horizontal period in which a select voltage is applied to the scanning line.

This makes it possible to input the data signal to one of the data lines as one group and to display images in an ON-period during which select voltage is applied to the scanning line, as previously described as the data line switching circuit.

Further, the active matrix display device of the present invention, which has a high flexibility in layout arrangement of circuits and can reduce the area of the frame part, is preferably used for a display device of a portable electronic device.

Further, the active matrix display device of the present invention, includes:

(a) an active matrix display panel having a scanning line and a plurality of data lines which are crossed with the scanning line;

(b) a data line switching circuit, including:

switching sections which are provided for the respective data lines on a signal input side of the data lines; and

input signal lines each of which combines the data lines as one group via the respective switching sections,

the switching sections for the respective data lines as one group being caused to drive alternatively so that a data signal inputted from the input signal line is supplied to one of the data lines as one group;

(c) a switching section drive circuit for outputting data line selecting signals each having an ON-voltage and an OFF-voltage in accordance with drive signals supplied from a drive control circuit so as to drive the switching sections in the data line switching circuit;

(d) a data line drive circuit for outputting to the data lines data signals in accordance with the respective data lines; and

(e) a scanning line drive circuit for outputting gate signals each having an ON-voltage and an OFF-voltage to the scanning line at a timing in accordance with the scanning line,

the switching section drive circuit being mounted in the scanning line drive circuit.

With this arrangement, the switching section drive circuit, mounted in the scanning line drive circuit, makes it possible to reduce the number of components. On this account, the area occupied with these circuit components is reduced on the frame part so that the layout of circuits on the frame part can be flexibly arranged, and consequently the frame part can be downsized. Also in the case of externally attaching the drive circuits such as the scanning line drive circuit and the data line drive circuit, the arrangement above enables to do away with the process to connect the switching section drive circuit to the liquid crystal panel, and hence it is possible to reduce the manufacturing cost.

Moreover, in such a case, the switching section drive circuit and the scanning line drive circuit are composed of level shifter circuits, so that it is advantageous that incorporating the switching section drive circuit into the gate line drive circuit can be carried out without significant changes in manufacturing steps of the gate line drive circuit.

Further, as described above, the active matrix display device of the present invention can be arranged so that the scanning line drive circuit includes a plurality of settable ON-voltages, and a data line selecting signal differs from a scanning signal in an absolute value of an ON-voltage.

In an arrangement in which the switching section drive circuit is mounted in the scanning line drive circuit, although also considered is an arrangement of the ON-voltage of the data line selecting signal having the same ON-voltage as the scanning signal outputted to the scanning line, a pixel switching element driven by the scanning signal differs in functions from the switching section driven by the data line selecting signal, so that ON-voltages suitable for the data line selecting signal and the scanning signal are different from each other.

For example, the ON-voltage of the pixel switching element is set to such a voltage that a charge of electricity can be provided to a pixel electrode excellently. On the other hand, the ON-voltage of the switching section in the data line switching circuit is set to such a voltage that the data signals supplied from the data line drive circuit can be supplied excellently to the respective data lines connected.

Thus, it is possible to make the switching sections to function properly by setting the absolute value of the ON-voltage of the data line selecting signal to a voltage value suitable for functions of the switching section driven by the data line selecting signal, as a value different from that of the ON-voltage of the scanning signal.

Moreover, for setting the absolute values of the ON-voltages to be different from each other, it is preferable that the data line selecting signal is smaller than the scanning signal in the absolute value of the ON-voltage.

The ON-voltage of the scanning signal needs to be high for excellently providing a charge of electricity to the pixel electrode of the pixel switching elements which are caused to drive by the scanning signals. All the switching section of the data line switching circuit has to do is, as described above, to supply the data signals supplied from the data line drive circuit to the respective data lines connected in a good condition, so that it can fulfill the function without setting the ON-voltage of the data line selecting signal as high as the ON-voltage of the scanning signal.

Therefore, setting the absolute value of the ON-voltage of the data line selecting signal to a value smaller than that of the ON-voltage of the scanning signal can increase a reliability of a switching characteristic of the switching section in the data line switching circuit, thereby maintaining a long-term reliability of the switching section.

As described above, the active matrix display device of the present invention can be arranged so that the switching section drive circuit includes a settable intermediate voltage which is a voltage level between the ON-voltage and the OFF-voltage, and the switching section drive circuit changes the voltage level between the ON-voltage and the OFF-voltage via a period of the intermediate voltage.

In an arrangement without the period of the intermediate voltage, at the time of voltage increase from the off-voltage to the on-voltage or at the time of voltage decrease from the on-voltage to the off-voltage, the electric power is supplied so that the electric potential is promptly increased or decreased. On this account, the power consumption of this arrangement is greater than that of the arrangement adopting the period of the intermediate voltage before switching the voltage level, and especially the data line selecting TFTs 13 are frequently driven and hence consume a large amount of electricity.

The above arrangement has the period of the intermediate voltage at the time of switching the voltage level, and thus, at the time of voltage increase, the voltage is increased from the off-voltage to the intermediate voltage by free discharging and the voltage is increased from the intermediate voltage to the on-voltage by the supply of electric power, and at the time of voltage decrease, the voltage is decreased from the on-voltage to the intermediate voltage by free discharging and the voltage is decreased from the intermediate voltage to the off-voltage by the supply of electric power. With this arrangement, it is possible to decrease the power consumption.

Moreover, in the above arrangement, it is preferable that the intermediate voltage is at a GND level.

To reduce the power consumption due to the current flowing towards the intermediate voltage, it is preferable that the impedance of the power supply for generating the intermediate voltage is as low as possible. However, even through a normal power supply (for instance a positive power supply or a negative power supply) has impedance lower than the impedances of other signal lines, this does not indicate that the impedance of the power supply is the lowest in the whole system. In the meantime, the GND is a reference voltage at the time of constructing a circuit power supply so that the impedance of the GND is very low compared with the impedances of other voltages (generally the lowest in the whole system). Thus, if the intermediate voltage is equivalent to the GND level, the power consumption owing to the current flowing towards the intermediate voltage can be reduced.

In a switching section drive circuit of an active matrix display device of the present invention, in which data line selecting signals each having an ON-voltage and an OFF-voltage are outputted to switching sections of a data line switching circuit,

the data line switching circuit includes:

the switching sections, on a signal input side of a plurality of data lines which are crossed with scanning line, being provided for the respective data lines; and

input signal lines each of which combines the data lines as one group via the respective switching sections,

the switching sections for the respective data lines as one group being caused to drive alternatively so that a data signal inputted from the input signal line is supplied to one of the data lines as one group,

the switching section drive circuit changing a voltage level between an ON-voltage and an OFF-voltage via a period of an intermediate voltage, which is settable and the voltage level between the ON-voltage and the OFF-voltage.

By mounting such a switching section drive circuit, as previously described as an active matrix display device, at the time of voltage increase, the voltage is increased from the off-voltage to the intermediate voltage by free discharging and the voltage is increased from the intermediate voltage to the on-voltage by the supply of electric power, and at the time of voltage decrease, the voltage is decreased from the on-voltage to the intermediate voltage by free discharging and the voltage is decreased from the intermediate voltage to the off-voltage by the supply of electric power. With this arrangement, it is possible to decrease the power consumption.

Moreover, in the above arrangement, it is also preferable that the intermediate voltage is at a GND level.

With the arrangement in which the intermediate voltage is equivalent to the GND level, as previously described as the active matrix display device, it is possible to reduce the power consumption due to the current flowing towards the intermediate voltage, so that the power consumption can be reduced in an extremely effective manner.

In a scanning line drive circuit of an active matrix display device of the present invention including a data line switching circuit, the data line switching circuit includes:

switching sections which are provided for the respective data lines on a signal input side of a plurality of data lines; and

input signal lines each of which combines the data lines as one group via the respective switching sections,

the switching sections for the respective data lines as one group being caused to drive alternatively so that a data signal inputted from the input signal line is supplied to one of the data lines as one group,

the scanning line drive circuit outputs scanning signals each having an ON-voltage and an OFF-voltage to scanning line, which is crossed with the data lines, at a timing in accordance with the scanning line, the scanning line drive circuit including:

a switching section drive circuit for outputting data line selecting signals each having an ON-voltage and an OFF-voltage in accordance with drive signals supplied from a drive control circuit so as to drive the switching sections of the data line switching circuit.

Such a scanning line drive circuit, as previously described as the active matrix display device, makes it possible to reduce the number of components. On this account, the area occupied with the circuits is reduced on the frame part so that the layout of the circuits on the frame part can be flexibly arranged, and consequently the frame part can be downsized. Also in the case of externally attaching the drive circuits such as the scanning line drive circuit and the data line drive circuit, the arrangement above enables to do away with the process to connect the switching section drive circuit to the liquid crystal panel, and hence it is possible to reduce the manufacturing cost.

Further, the scanning line drive circuit of the active matrix display device of the present invention can be arranged so that a plurality of ON-voltages are settable, and a data line selecting signal differs from a scanning signal in an absolute value of an ON-voltage.

The scanning line drive circuit arranged in such a manner, as previously described as the active matrix display device, can make the switching sections to function properly by setting the ON-voltage of the data line selecting signal to a voltage value suitable for the function of the switching section driven by the data line selecting signal, regardless of the ON-voltage of the scanning signal.

Also in such a case, for setting the absolute values of the ON-voltages to be different from each other, it is preferable that the data line selecting signal is smaller than the scanning signal in the absolute value of the ON-voltage.

The scanning drive circuit arranged in such a manner makes it possible to increase a reliability of switching characteristic in the switching section of the data line switching circuit, thereby maintaining a long-term reliability of the switching section.

Further, the scanning line drive circuit of the active matrix display device of the present invention can be arranged so that the switching section drive circuit includes a settable intermediate voltage which is a voltage level between an ON-voltage and an OFF-voltage, and the switching section drive circuit changes the voltage level between the ON-voltage and the OFF-voltage via a period of the intermediate voltage.

The scanning drive circuit arranged in such a manner makes it possible that, as previously described as an active matrix display device, at the time of voltage increase, the voltage is increased from the off-voltage to the intermediate voltage by free discharging and the voltage is increased from the intermediate voltage to the on-voltage by the supply of electric power, and at the time of voltage decrease, the voltage is decreased from the on-voltage to the intermediate voltage by free discharging and the voltage is decreased from the intermediate voltage to the off-voltage by the supply of electric power. With this arrangement, it is possible to decrease the power consumption.

Moreover, in the above arrangement, it is also preferable that the intermediate voltage is at a GND level. With the arrangement in which the intermediate voltage is equivalent to the GND level, as previously described as the active matrix display device, it is possible to reduce the power consumption due to the current flowing towards the intermediate voltage, so that the power consumption can be reduced in an extremely effective manner.

In a scanning line drive circuit of the active matrix display device of the present invention, provided in an active matrix display device having a scanning line and a plurality of data lines which are crossed with the scanning line, which outputs scanning signals each having an ON-voltage and an OFF-voltage at a timing in accordance with the scanning line,

a plurality of settable ON-voltages are provided so that a signal having an OFF-voltage and an ON-voltage which is different from that of the scanning signal can be outputted.

As previously described as the active matrix display device, the active matrix display device in which the data line switching circuit is mounted, adopting the scanning line drive circuit arranged in such a manner, makes it possible to drive the switching sections in the data line switching circuit only by the scanning line drive circuit.

As compared with the arrangement in which a switching section drive circuit is provided separately, the arrangement above makes it possible to reduce the number of circuit components in the frame part. On this account, the area occupied with these circuit components is reduced on the frame part so that the layout of circuits on the frame part can be flexibly arranged, and consequently the frame part can be downsized. Also in the case of externally attaching the drive circuits such as the scanning line drive circuit and the data line drive circuit, the arrangement above enables to do away with the process to connect the switching section drive circuit to the liquid crystal panel, and hence it is possible to reduce the manufacturing cost.

A driving method of the active matrix display device of the present invention, includes the steps of:

(a) providing switching sections for respective plural data lines which are crossed with a scanning line;

(b) making the data lines to be combined as one group via the switching sections; and

(c) driving the switching sections for the data lines as one group so that an inputted data signal is supplied to one of the data lines as one group,

the method using an ON-voltage having an absolute value different from that of an ON-voltage of a scanning signal in driving the switching sections.

By driving in such a driving method, as previously described as the active matrix display device, it is possible to make the switching sections to function properly by setting the ON-voltage of the data line selecting signal to a voltage value suitable for the function of the switching section driven by the data line selecting signal, regardless of the ON-voltage of the scanning signal.

Also in such a case, for setting the absolute values of the ON-voltages to be different from each other, it is preferable that the data line selecting signal is smaller than the scanning signal in the absolute value of the ON-voltage.

With this arrangement, as previously described as the active matrix display device, it is possible to increase a reliability of switching characteristic in the switching section of the data line switching circuit, thereby maintaining a long-term reliability of the switching section.

A driving method of the active matrix display device of the present invention, includes the steps of:

(a) providing switching sections for respective plural data lines which are crossed with a scanning line;

(b) making the data lines to be combined as one group via the switching sections; and

(c) driving the switching sections for the data lines as one group so that an inputted data signal is supplied to one of the data lines as one group,

wherein a voltage level between an ON-voltage and an OFF-voltage is changed via a period of an intermediate voltage in the step (c).

By driving in such a driving method, as previously described as an active matrix display device, at the time of voltage increase, the voltage is increased from the off-voltage to the intermediate voltage by free discharging and the voltage is increased from the intermediate voltage to the on-voltage by the supply of electric power, and at the time of voltage decrease, the voltage is decreased from the on-voltage to the intermediate voltage by free discharging and the voltage is decreased from the intermediate voltage to the off-voltage by the supply of electric power. With this arrangement, it is possible to decrease the power consumption.

Moreover, in the above arrangement, it is also preferable that the intermediate voltage is at a GND level. With the arrangement in which the intermediate voltage is equivalent to the GND level, as previously described as the active matrix display device, it is possible to reduce the power consumption due to the current flowing towards the intermediate voltage, so that the power consumption can be reduced in an extremely effective manner.

Further, the active matrix display device of the present invention, which has a high flexibility in layout arrangement of circuits and can reduce the area of the frame part, is preferably used for a display device of a portable electronic device.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A data line switching circuit of an active matrix display panel having a scanning line and a plurality of data lines which are crossed with the scanning line,
the data line switching circuit, comprising:
switching sections which are provided for the respective data lines on a signal input side of the data lines; and
input signal lines each of which combines the data lines as one group via the respective switching sections,
wherein the switching sections for the respective data lines as one group are caused to drive alternatively so that a data signal inputted from the input signal line is supplied to one of the data lines as one group, and
the switching section is composed of a plurality of switching elements which are connected in parallel to each other.

2. The data line switching circuit according to claim 1, wherein the plurality of switching elements constructing the switching section are capable of driving independently from each other, and are caused to drive selectively in a period during which the switching section is caused to drive.

3. The data line switching circuit according to claim 2, wherein the plurality of switching elements constructing the switching section are caused to drive so that a driving frequency equals between the switching elements in one switching section.

4. The data line switching circuit according to claim 1, wherein the switching sections for the respective data lines as one group are caused to drive one by one at a cycle of H/X, where X is a number of the data lines as one group, and H is one horizontal period in which an ON-voltage is applied to the scanning line.

5. A switching section drive circuit which drives switching sections in a data line switching circuit of an active matrix display panel, having a scanning line and a plurality of data lines which are crossed with the scanning line, in accordance with drive signals supplied from a drive control circuit,
the data line switching circuit, including:
the switching sections which are provided for the respective data lines on a signal input side of the data lines; and
input signal lines each of which combines the data lines as one group via the respective switching sections,
the switching sections for the respective data lines as one group being caused to drive alternatively so that a data signal inputted from the input signal line is supplied to one of the data lines as one group,
each of the switching sections being composed of a plurality of switching elements, which are connected in parallel to each other and are capable of driving independently from each other,
the switching section drive circuit driving the switching elements constructing the switching section selectively in a period during which the switching section is caused to drive.

6. The switching section drive circuit according to claim 5, which drives the plurality of switching elements constructing the switching section so that a driving frequency equals between the switching elements in one switching section.

7. The switching section drive circuit according to claim 5, which drives the switching sections for the respective data lines as one group one by one at a cycle of H/X, where X is a number of the data lines as one group, and H is one horizontal period in which an ON-voltage is applied to the scanning line.

8. A drive control circuit which outputs drive signals to a switching section drive circuit for driving switching sections in a data line switching circuit of an active matrix display panel having a scanning line and a plurality of data lines which are crossed with the scanning line,
the data line switching circuit, including:
the switching sections which are provided for the respective data lines on a signal input side of the data lines; and
input signal lines each of which combines the data lines as one group via the respective switching sections,
the switching sections for the respective data lines as one group being caused to drive alternatively so that a data signal inputted from the input signal line is supplied to one of the data lines as one group,
each of the switching sections being composed of a plurality of switching elements, which are connected in parallel to each other and are capable of driving independently from each other,
the drive control circuit outputting the drive signals so that the switching elements are caused to drive selectively in a period during which the switching section is caused to drive in the switching section drive circuit.

9. The drive control circuit according to claim 8, which outputs the drive signals so that a driving frequency equals between the switching elements in one switching section when the switching elements are caused to drive selectively.

10. The drive control circuit according to claim 8, which outputs the drive signals so that the switching sections for the respective data lines as one group are caused to drive one by one at a cycle of H/X, where X is a number of the data lines as one group, and H is one horizontal period in which an ON-voltage is applied to the scanning line.

11. An active matrix display panel, having a scanning line and a plurality of data lines which are crossed with the scanning line, in which
a data line switching circuit, includes:
switching sections which are provided for the respective data lines on a signal input side of the data lines; and
input signal lines each of which combines the data lines as one group via the respective switching sections,
wherein the switching sections for the respective data lines as one group are caused to drive alternatively so that a data signal inputted from the input signal line is supplied to one of the data lines as one group, and
each of the switching sections is composed of a plurality of switching elements which are connected in parallel to each other.

12. The active matrix display panel according to claim 11, wherein the plurality of switching elements constructing the switching section are capable of driving independently from each other, and are caused to drive selectively in a period during which the switching section is caused to drive.

13. An active matrix display device, comprising:
(a) an active matrix display panel having a scanning line and a plurality of data lines which are crossed with the scanning line;
(b) a data line switching circuit, including:
switching sections which are provided for the respective data lines on a signal input side of the data lines; and
input signal lines each of which combines the data lines as one group via the respective switching sections,
the switching sections for the respective data lines as one group being caused to drive alternatively so that a data signal inputted from the input signal line is supplied to one of the data lines as one group,
each of the switching sections being composed of a plurality of switching elements which are connected in parallel to each other;
(c) a data line drive circuit for outputting to the data lines data signals in accordance with the respective data lines; and
(d) a scanning line drive circuit for outputting gate signals each having an ON-voltage and an OFF-voltage to the scanning line at a timing in accordance with the scanning line.

14. An active matrix display device, comprising:
(a) an active matrix display panel having a scanning line and a plurality of data lines which are crossed with the scanning line;
(b) a data line switching circuit, including:
switching sections which are provided for the respective data lines on a signal input side of the data lines; and
input signal lines each of which combines the data lines as one group via the respective switching sections,
the switching sections for the respective data lines as one group being caused to drive alternatively so that a data signal inputted from the input signal line is supplied to one of the data lines as one group;
(c) a switching section drive circuit for driving the switching sections in the data line switching circuit in accordance with drive signals;
(d) a drive control circuit for outputting the drive signals to the switching section drive circuit;
(e) a data line drive circuit for outputting to the data lines data signals in accordance with the respective data lines; and
(f) a scanning line drive circuit for outputting gate signals each having an ON-voltage and an OFF-voltage to the scanning line at a timing in accordance with the scanning line,
wherein each of the switching section is composed of a plurality of switching elements which are capable of driving independently from each other and are caused to drive selectively in a period during which the switching section is caused to drive by the switching section drive circuit.

15. The active matrix display device according to claim 14, wherein the switching section drive circuit is mounted in the scanning line drive circuit.

16. The active matrix display device according to claim 15, wherein the scanning line drive circuit includes a plurality of settable ON-voltages, and a data line selecting signal differs from a scanning signal in an absolute value of an ON-voltage.

17. The active matrix display device according to claim 16, wherein the data line selecting signal is smaller than the scanning signal in the absolute value of the ON-voltage.

18. The active matrix display device according to claim 15, wherein the switching section drive circuit includes a settable intermediate voltage which is a voltage level between an ON-voltage and an OFF-voltage, and the switching section drive circuit changes the voltage level between the ON-voltage and the OFF-voltage via a period of the intermediate voltage.

19. The active matrix display device according to claim 18, wherein the intermediate voltage is at a GND level.

20. The active matrix display device according to claim 13, wherein at least any one of the data line drive circuit, the scanning line drive circuit, or the switching section drive circuit is provided on a substrate which is same as a substrate constructing the active matrix display panel.

21. The active matrix display device according to claim 13, wherein
the switching section drive circuit drives the switching sections for the respective data lines as one group one by one at a cycle of H/X, where X is a number of the data lines as one group, and H is one horizontal period in which an ON-voltage is applied to the scanning line.

22. The active matrix display device according to claim 13, which is a display device of a portable electronic device.

23. An active matrix display device, comprising:
(a) an active matrix display panel having a scanning line and a plurality of data lines which are crossed with the scanning line;
(b) a data line switching circuit, which is provided on a signal input side of the data lines in the active matrix display panel, including:
switching sections which are provided for the respective data lines; and
input signal lines each of which combines the data lines as one group via the respective switching sections,
the switching sections for the respective data lines as one group being caused to drive alternatively so that a data signal inputted from the input signal line is supplied to one of the data lines as one group;
(c) a switching section drive circuit for outputting data line selecting signals each having an ON-voltage and an OFF-voltage in accordance with drive signals supplied from a drive control circuit so as to drive the switching sections in the data line switching circuit;
(d) a data line drive circuit for outputting to the data lines data signals in accordance with the respective data lines; and
(e) a scanning line drive circuit for outputting gate signals each having an ON-voltage and an OFF-voltage to the scanning line at a timing in accordance with the scanning line,
the switching section drive circuit being mounted in the scanning line drive circuit.

24. The active matrix display device according to claim 23, wherein the scanning line drive circuit includes a plurality of settable ON-voltages, and a data line selecting signal differs from a scanning signal in an absolute value of an ON-voltage.

25. The active matrix display device according to claim 24, wherein the data line selecting signal is smaller than the scanning signal in the absolute value of the ON-voltage.

26. The active matrix display device according to claim 23, wherein the switching section drive circuit includes a settable intermediate voltage which is a voltage level between the ON-voltage and the OFF-voltage, and the switching section drive circuit changes the voltage level between the ON-voltage and the OFF-voltage via a period of the intermediate voltage.

27. The active matrix display device according to claim 26, wherein the intermediate voltage is at a GND level.

28. A switching section drive circuit of an active matrix display device, in which data line selecting signals each having an ON-voltage and an OFF-voltage are outputted to switching sections of a data line switching circuit,
the data line switching circuit including:
the switching sections, on a signal input side of a plurality of data lines which are crossed with a scanning line, being provided for the respective data lines; and
input signal lines each of which combines the data lines as one group via the respective switching sections,
the switching sections for the respective data lines as one group being caused to drive alternatively so that a data signal inputted from the input signal line is supplied to one of the data lines as one group,
the switching section drive circuit changing a voltage level between an ON-voltage and an OFF-voltage via a period of an intermediate voltage, which is settable and the voltage level between the ON-voltage and the OFF-voltage.

29. The switching section drive circuit according to claim 28, wherein the intermediate voltage is at a GND level.

30. A scanning line drive circuit of an active matrix display device including a data line switching circuit including:
switching sections which are provided for the respective data lines on a signal input side of a plurality of data lines; and
input signal lines each of which combines the data lines as one group via the respective switching sections,
the switching sections for the respective data lines as one group being caused to drive alternatively so that a data signal inputted from the input signal line is supplied to one of the data lines as one group,
the scanning line drive circuit outputting scanning signals each having an ON-voltage and an OFF-voltage to a scanning line, which is crossed with the data lines, at a timing in accordance with the scanning line, the scanning line drive circuit including:
a switching section drive circuit for outputting data line selecting signals each having an ON-voltage and an OFF-voltage in accordance with drive signals supplied from a drive control circuit so as to drive the switching sections of the data line switching circuit.

31. The scanning line drive circuit according to claim 30, wherein a plurality of ON-voltages are settable, and a data line selecting signal differs from a scanning signal in an absolute value of an ON-voltage.

32. The scanning line drive circuit according to claim 31, wherein the data line selecting signal is smaller than the scanning signal in the absolute value of the ON-voltage.

33. The scanning line drive circuit according to claim 30, wherein the switching section drive circuit includes a settable intermediate voltage which is a voltage level between an ON-voltage and an OFF-voltage, and the switching section drive circuit changes the voltage level between the ON-voltage and the OFF-voltage via a period of the intermediate voltage.

34. The scanning line drive circuit according to claim 33, wherein the intermediate voltage is at a GND level.

35. A scanning line drive circuit, provided in an active matrix display device having a scanning line and a plurality of data lines which are crossed with the scanning line, which outputs scanning signals each having an ON-voltage and an OFF-voltage at a timing in accordance with the scanning line,
wherein a plurality of settable ON-voltages are provided so that a signal having an OFF-voltage and an ON-voltage which is different from that of the scanning signal can be outputted.

36. A driving method of an active matrix display device, comprising the steps of:
(a) providing switching sections for respective plural data lines which are crossed with a scanning line;
(b) making the data lines to be combined as one group via the switching sections; and
(c) driving the switching sections for the data lines as one group so that an inputted data signal is supplied to one of the data lines as one group,
the method using an ON-voltage having an absolute value different from that of an ON-voltage of a scanning signal in driving the switching sections.

37. The driving method of an active matrix display device, according to claim 36, wherein the ON-voltage having the absolute value smaller than that of the ON-voltage of the scanning signal.

38. A driving method of an active matrix display device, comprising the steps of:
(a) providing switching sections for respective plural data lines which are crossed with a scanning line;
(b) making the data lines to be combined as one group via the switching sections; and
(c) driving the switching sections for the data lines as one group so that an inputted data signal is supplied to one of the data lines as one group,
wherein a voltage level between an ON-voltage and an OFF-voltage is changed via a period of an intermediate voltage in the step (c).

39. The driving method of the active matrix display device according to claim 38, wherein the intermediate voltage is at a GND level.

40. The active matrix display device according to claim 23, which is a display device of a portable electronic device.
